(19) United States
(12) Patent Application Publication
(10) Pub. No.: US 2012/0123788 A1
(43) Pub. Date: May 17, 2012

(54) CODING METHOD, DECODING METHOD, AND DEVICE AND PROGRAM USING THE METHODS

(75) Inventors: Kimitaka Tsutsumi, Tokyo (JP); Shigeaki Sasaki, Tokyo (JP); Yusuke Hiwasaki, Tokyo (JP); Masahiro Fukui, Tokyo (JP)

(73) Assignee: NIPPON TELEGRAPH AND TELEPHONE CORPORATION, Tokyo (JP)

(21) Appl. No.: 13/377,983

(22) PCT Filed: Jun. 22, 2010
(86) PCT No.: PCT/JP10/60522

§ 371 Date: Jan. 31, 2012

(30) Foreign Application Priority Data
Jun. 23, 2009 (JP) 2009-148793

(51) Int. Cl. H04B 1/66; G10L 19/00

(52) U.S. Cl. 704/500; 704/E19.003

(57) ABSTRACT

A high-quality decoded signal is synthesized. A coding method of the present invention includes a local decoding coefficient searching step. The local decoding coefficient searching step includes a replication determining sub-step, a candidate replication shift signal sequence generating sub-step, a distance calculating sub-step, and a minimum distance shift amount finding sub-step. The replication determining sub-step determines, for each source signal sequence to be coded, whether or not a candidate replication shift signal sequence is to be generated from a decoded signal sequence and outputs a replication determination flag. If the replication determination flag indicates that a candidate replication shift signal sequence is to be generated, the candidate replication shift signal sequence generating sub-step generates a candidate replication shift signal sequence for each predetermined candidate signal shift amounts. The distance calculating sub-step calculates a parameter representing the distance between predetermined signal sequences. The minimum distance shift amount finding step obtains a signal shift amount that minimizes the distance.

### TECHNICAL FIELD

The present invention relates to a coding method and a decoding method for audio signals, such as speech signals, and a device and a program using the methods and, in particular, to a technique for compensating for information lost during coding and transmission of information, in which a code obtained by using a portion of lost information is added to a code transmitted to recover lost information during decoding.

### BACKGROUND ART

When data is lost during coding of an input signal at a low bit rate or during transmission of such coded data, an extremely large difference between the input signal and a decoded signal (coding distortion) can be caused by lack of bits or lost bits. A large coding distortion can be perceived as uncomfortable noise. In one existing technique for concealing noise caused by data losses during transmission, a certain feature quantity of a signal is obtained and a previous decoded signal having a feature quantity close to that of the decoded signal is copied (Patent literature 1).

FIG. 1 illustrates an exemplary functional configuration of a speech signal transmitter 1 in Patent literature 1 and FIG. 2 illustrates an exemplary functional configuration of a speech signal receiver 2. An input speech signal is stored in an input buffer 10 of the transmitter 1 and the speech signal is divided into regular time periods called frames, that is, the speech signal is framed, before being sent to a speech waveform coding part 30. The input speech signal is converted to a speech code in the speech waveform coding part 30. The speech code is sent to a packet building part 70. A speech feature quantity calculating part 40 uses the speech signal stored in the input buffer 10 to calculate a speech feature quantity of the speech signal in the frame. The speech feature quantity is a feature such as a pitch period (which is equivalent to the fundamental frequency of speech) or power and only one of the features or all of the features may be used.

A speech feature quantity coding part 50 quantizes the speech feature quantity so that the speech feature quantity can be expressed by a predetermined number of bits, and then transforms the quantized speech feature quantity to a code. The coded speech feature quantity is sent to a shift buffer 60. The shift buffer 60 holds the speech feature quantity codes of a prespecified number of frames. When delay control information, which will be described later, is input in the shift buffer 60, the shift buffer 60 sends the code of the speech feature quantity of the speech signal of a frame the number of frames earlier specified in the delay control information, that is, a past frame, to the packet building part 70. A remaining buffer capacity coding part 20 receives a remaining buffer capacity and codes the remaining buffer capacity. The remaining buffer capacity code is also sent to the packet building part 70. The packet building part 70 uses the code of the speech signal waveform, the code of the speech feature quantity, the delay control information and the remaining buffer capacity code to build a packet. A packet transmitting part 80 receives the packet information built by the packet building part 70 and sends out the packet information onto a packet communication network as a speech packet.

A packet receiving part 81 of the speech signal receiver 2 receives the speech packet through the packet communication network and stores the speech packet in a receiver buffer 71. The code of the speech signal waveform contained in the received speech packet is sent to a speech packet decoding part 31, where the code is decoded. In a frame in which no packet loss has occurred, the signal output from the speech packet decoding part 31 is output as an output speech signal through a selector switch 32. A remaining buffer capacity decoding part 21 obtains, from the remaining buffer capacity code contained in the received speech packet, delay control information that specifies the number of frames by which auxiliary information is to be delayed and added to a packet. The obtained delay control information is sent to the shift buffer 60 and the packet building part 70 in FIG. 1. The delay control information contained in the received speech packet is used in a loss processing control part. A remaining receiver buffer capacity determining part 22 detects the number of packet frames stored in the receiver buffer 71. The remaining buffer capacity is sent to the remaining buffer capacity coding part 20 in FIG. 1.

A loss detecting part 90 detects a packet loss. Packets received at the packet receiving part 81 are stored in the receiver buffer 71 in the order of packet number, that is, frame number. The packets stored are read from the receiver buffer 71 and, if a packet to be read is missing, the loss detecting part 90 determines that a packet loss has occurred immediately before the reading operation and turns the selector switch 32 to the output side of the loss processing control part. The invention in Patent literature 1 performs the process described above to conceal noise caused by data loss during transmission.

The loss processing control part functions as follows. Suppose that a packet loss has occurred in frame n. When a packet loss occurs, a receiver buffer searching part 100 searches through the received packets stored in the receiver buffer 71 for a packet that is close in time to the lost frame n (a packet with the timestamp closest to that of the lost packet) among the packets received in frame n+1 or later frames. The code of a speech signal waveform contained in the packet is decoded by a read-ahead speech waveform decoding part 32 to obtain a speech signal waveform. The receiver buffer searching part 100 further searches through the packets stored in the receiver buffer 71 for a packet to which auxiliary information corresponding to the speech signal in the lost frame n has been added. If such a packet is found by the packet search, a speech feature quantity decoding part 51 decodes the found auxiliary information corresponding to the speech signal in the lost frame n into pitch information and power information of the speech signal in the lost frame n and sends the pitch information and the power information to a lost signal generating part 110. On the other hand, the output speech signal is stored in an output speech buffer 130. If such packet is not found by the packet search, the pitch period of the output signal in the output speech buffer 130 is analyzed by a pitch extracting part 120. The pitch extracted by the pitch extracting part 120 is the pitch corresponding to the speech signal in the frame n−1 immediately preceding the lost frame. The pitch corresponding to the speech signal in the immediately preceding frame n−1 is sent to the lost signal generating part 110. The lost signal generating part 110 uses the pitch information sent from the speech feature quantity decoding part 51 or the pitch extracting part 120 to extract a speech waveform from the output speech buffer on a pitch-by-pitch basis and generates a speech waveform corresponding to the lost packet. Thus, more natural decoded speech can be obtained in case of packet loss, because the waveform is repeated on a pitch-by-pitch basis of the speech waveform corresponding to the lost packet, rather than repeating a waveform on a pitch-by-pitch basis of the packet immediately before the lost packet.

### PRIOR ART LITERATURE

### Patent Literature

Patent literature 1: WO 2005/109401

### SUMMARY OF INVENTION

### Problem to be Solved by the Invention

The invention in Patent literature 1 encodes a feature quantity such as a pitch or power and transmits the feature quantity with a time delay. Therefore, if a packet to be decoded is missing, the invention in Patent literature 1 can synthesize a signal close to the lost signal by decoding a coded feature quantity and obtaining a signal that has a value close to the feature quantity from the receiver buffer. However, the invention in Patent literature 1 has a problem that processing for generating high-quality decoded speech cannot be performed with an encoder and a decoder alone because some feature quantity needs to be encoded and transmitted and information concerning the receiver buffer needs to be communicated to the transmitter.

### Means to Solve the Problem

A coding method of the present invention includes a source signal sequence generating step, a signal coding step, a signal decoding step, a local decoding coefficient searching step, and a code multiplexing step. The source signal sequence generating step generates a signal sequence including a predetermined number of signals from an audio signal and outputs the signal sequence as a source signal sequence to be coded. For example, an audio signal is divided into frames, each containing a predetermined number of signals, and the sequence signals making up one frame is output as a source signal sequence to be coded. Alternatively, a frame may be further divided into sub-frames and a signal sequence making up each sub-frame may be output as a source signal sequence to be coded. Alternatively, a signal sequence in a frame or in neighboring several frames may be frequency-transformed to a frequency-domain signal sequence and the frequency-domain signal sequence may be output as a source signal sequence to be coded. Alternatively, a frequency-domain signal sequence may be divided into sub-bands and frequency-domain signals making up a sub-band may be output as a source signal sequence to be coded. The signal coding step codes each source signal sequence and outputs a code index. The signal decoding step decodes the code index and outputs a decoded signal sequence. The local decoding coefficient searching step outputs replication shift information from the source signal sequence and the decoded signal sequence. The code multiplexing step multiplexes at least the code index and the replication shift information to generate a transmitter signal.

The local decoding coefficient searching step includes a replication determining sub-step, a candidate replication shift signal sequence generating sub-step, a distance calculating sub-step, and a minimum distance shift amount finding sub-step. The replication determining sub-step determines, for each source signal sequence, whether or not a candidate replication shift signal sequence is to be generated from a decoded signal sequence, and outputs a replication determination flag. For example, if the power of the decoded signal sequence is less than or equal to a threshold value, the replication determining sub-step may output a replication determination flag indicating that a candidate replication shift signal sequence is to be generated. Alternatively, if the power of the difference between the source signal sequence and the decoded signal sequence is greater than a threshold value, the replication determining sub-step may output a replication determination flag indicating that a candidate replication shift signal sequence is to be generated. Alternatively, the signal decoding step may calculate the number of bits to be allocated to each source signal sequence and output the number of bits as bit allocation information and the replication determination step may output a replication determination flag indicating that a candidate replication shift signal sequence is to be generated if the number of bits to be allocated to the source signal sequence is less than or equal to a threshold value.

The candidate replication shift signal sequence generating sub-step generates a candidate replication shift signal sequence for each predetermined candidate shift amount if the replication determination flag indicates that a candidate replication shift signal sequence is to be generated. For example, a candidate replication shift signal sequence \dot{S}_{τ}[k] (where k=0, . . . , L−1 and L is the number of signals in the source signal sequence) may be obtained from a decoded signal sequence Ŝ[k]. If the source signal sequence is one of sub-band frequency-domain signal sequences S^{(w)}[k] into which a frequency-domain signal sequence has been divided according to frequency bands (where w=0, . . . , W−1, k=0, . . . , L′−1, W is the number of divisions, and L′ is the number of signals included in one sub-band frequency-domain signal sequence), the candidate replication shift signal sequence generating step may use a decoded signal sequence Ŝ^{(w)[k] corresponding to a sub-band frequency-domain signal sequence provided by dividing the same frequency domain signal sequence to obtain a candidate replication shift signal sequence \dot{S}}_{τ}^{(w)[k].}

The distance calculating sub-step calculates a parameter representing the distance between predetermined signal sequences. The parameter representing the distance between predetermined signal sequences may be a parameter representing the distance between a candidate replication shift signal sequence and the source signal sequence or may be a parameter representing the distance between the source signal sequence and a candidate complementary decoded signal sequence which is a candidate replication shift signal sequence plus a decoded signal sequence. Alternatively, a signal sequence may be considered a vector and the parameter representing the distance between signal sequences may be the sum of squares of the difference between elements of the vector (Euclidean distance) or may be the inner product of two signal sequences. The minimum distance shift amount finding sub-step obtains a signal shift amount that minimizes the distance from the results of calculation at the distance calculating sub-step (the parameter representing the distance). The signal shift amount to be selected depends on the method of calculation used at the distance calculating sub-step (the parameter representing the distance). If the parameter representing the distance is Euclidean distance, a signal shift amount that minimizes the parameter representing the distance may be selected. If the parameter representing the distance is inner product, a signal shift amount that maximizes the parameter representing the distance may be selected.

A decoding method of the present invention includes a code demultiplexing step, a signal decoding step, a local decoding coefficient replicating step, and a recovered signal generating step. The code demultiplexing step reads a code index and replication shift information from a received signal and output the code index and the replication shift information. If the received signal also includes replication determination flag, the code demultiplexing step also outputs the replication determination flag. The signal decoding step decodes the code index and outputs a decoded signal sequence. The local decoding coefficient replicating step generates a complementary decoded signal sequence from the decoded signal sequence and the replication shift information. The recovered signal generating step generates a recovered signal which is a signal representing original audio information from the complementary decoded signal sequence. The complementary decoded signal sequence corresponds to the source signal sequence, examples of which have been given in the description of the coding method. That is, the complementary decoded signal sequence may be a signal sequence making up a frame, a signal sequence making up a sub-frame, a frequency-domain signal sequence, or a signal sequence making up a sub-band, for example. The recovered signal generating step recovers any of these types of complementary decoded signal sequences to the original audio signal and may perform processing that is determined appropriately for the type of the complementary decoded signal sequence.

The local decoding coefficient replicating step includes a replication determining sub-step, a replication shift signal sequence generating sub-step, and a complementary decoded signal sequence generating sub-step. The replication determining sub-step determines whether or not a replication shift signal sequence is to be generated from a decoded signal sequence or from the result of bit allocation performed using a first decoded signal, and outputs a replication determination flag. If the received signal also includes a replication determination flag, the replication determining sub-step is not required.

The replication shift signal sequence generating sub-step generates a replication shift signal sequence on the basis of the shift amount indicated by the replication shift information if the replication determination flag indicates that a candidate replication shift signal sequence is to be generated. For example, a candidate replication shift signal sequence \dot{S}_{τ}[k] may be obtained from a decoded signal sequence Ŝ[k] and the shift amount indicated by the replication shift information. If a decoded signal sequence Ŝ_{(w)[k] is a signal sequence corresponding to a sub-band frequency-domain signal sequence S}^{(w)[k] provided by dividing a frequency-domain signal sequence according to frequency bands, the replication shift signal sequence generating sub-step may obtain the replication shift signal sequence \dot{S}}^{(w)}[k] by using a decoded signal sequence Ŝ^{(w)}[k] corresponding to a sub-band frequency-domain signal sequence provided by dividing the same frequency-domain signal sequence.

The complementary decoded signal sequence generating sub-step sets the replication shift signal sequence as a complementary decoded signal sequence and outputs the complementary decoded signal if the replication determination flag indicates that a candidate replication shift signal sequence is to be generated. If the replication determination flag indicates that a candidate replicated signal sequence is not to be generated, the complementary decoded signal sequence generating sub-step sets and outputs the decoded signal sequence as a complementary decoded signal sequence. The complementary decoded signal sequence generating sub-step may add the decoded signal sequence and the replication shift signal sequence together and output the sum as a complementary decoded signal sequence if the replication determination flag indicates that a candidate replication shift signal sequence is to be generated.

### Effects of the Invention

According to the coding method and the decoding method of the present invention, a signal obtained by shifting a decoded signal in time domain or frequency domain is copied or added to the decoded signal to reduce coding distortion and reduce auditory noise.

Because the signal to be copied is obtained by shifting the decoded signal in time domain or frequency domain, the following effects can be attained. The number of bits required for reducing noise can be reduced because bits for sending the signal to be copied are not required. In particular, when a frequency band is divided into frequency band equal-sized blocks (hereinafter referred to as “sub-bands”), signals corresponding to the sub-bands have correlation to one another. Therefore, particularly in high frequency bands such as 4 to 14 kHz, auditory noise can be reduced by copying or adding a signal in a neighboring sub-band to a sub-band to generate a signal of the sub-band. For a signal in time domain, when a frame is divided into equal-sized blocks (hereinafter referred to as “sub-frames”), signals corresponding to the sub-frames have correlation to one another. Therefore, auditory noise can be reduced by copying or adding the signal in a neighboring sub-frame to a sub-frame to generate a signal of the sub-frame.

Furthermore, since the signal to be copied or added to the decoded signal is generated by shifting the decoded signal in time domain or frequency domain and the amount of the shift when the distance between the input signal and a new decoded signal generated from the original decoded signal and the generated decoded signal is minimum is coded with a small number of bits and transmitted, the signal to be added or copied to the decoded signal for reducing coding distortion can be specified with a small number of bits.

Thus, auditory noise caused by a frequency band or a time range that has a large coding distortion can be reduced and the subjective quality of the decoded signal can be improved by using only a small number of bits.

### BRIEF DESCRIPTION OF THE DRAWINGS

FIG. 1 is a diagram illustrating an exemplary functional configuration of an existing speech signal transmitter;

FIG. 2 is a diagram illustrating an exemplary functional configuration of an existing speech signal receiver;

FIG. 3A illustrates an exemplary configuration of a coding device of a first embodiment;

FIG. 3B illustrates an exemplary configuration of a decoding device of the first embodiment;

FIG. 4A illustrates an exemplary configuration of a local decoding coefficient searching part and of the first embodiment;

FIG. 4B illustrates an exemplary configuration of a local decoding coefficient replicating part of the first embodiment;

FIG. 5A illustrates an exemplary process flow in the coding device of the first embodiment;

FIG. 5B illustrates an exemplary process flow in the decoding device of the first embodiment;

FIG. 6A illustrates conceptual diagrams of transformation of a time-domain signal sequence to a frequency-domain signal sequence using discrete fourier transform or discrete cosine transform;

FIG. 6B illustrates conceptual diagrams of transformation of a time-domain signal sequence to a frequency-domain signal sequence using MDCT;

FIG. 7 is a diagram illustrating a method for generating candidate replication shift signal sequences;

FIG. 8A illustrates an exemplary configuration of a coding device of a variation of the first embodiment;

FIG. 8B illustrates an exemplary configuration of a decoding device of the variation of the first embodiment;

FIG. 9A illustrates an exemplary process flow in the coding device of the variation of the first embodiment;

FIG. 9B illustrates an exemplary process flow in the decoding device of the variation of the first embodiment;

FIG. 10A illustrates an exemplary configuration of a coding device of a second embodiment;

FIG. 10B illustrates an exemplary configuration of a decoding device of the second embodiment;

FIG. 11A illustrates an exemplary configuration of a local decoding coefficient searching part of the second embodiment;

FIG. 11B illustrates an exemplary configuration of a local decoding coefficient replicating part of the second embodiment;

FIG. 12A illustrates an exemplary process flow in the coding device of the second embodiment;

FIG. 12B illustrates an exemplary process flow in the decoding device of the second embodiment;

FIG. 13 is a diagram illustrating a method for generating a candidate complementary decoded signal sequence;

FIG. 14A illustrates an exemplary configuration of a coding device of a third embodiment;

FIG. 14B illustrates an exemplary configuration of a decoding device of the third embodiment;

FIG. 15A illustrates an exemplary configuration of a local decoding coefficient searching part of the third embodiment;

FIG. 15B illustrates an exemplary configuration of a local decoding coefficient replicating part of the third embodiment;

FIG. 16A illustrates an exemplary process flow in the coding device of the third embodiment;

FIG. 16B illustrates an exemplary process flow in the decoding device of the third embodiment;

FIG. 17A illustrates a conceptual diagram of transformation of a frequency-domain signal sequence to sub-band frequency-domain signal sequences;

FIG. 17B illustrates a conceptual diagram of transformation of sub-band complementary decoded signal sequences to a complementary decoded signal sequence;

FIG. 18 is a diagram illustrating relationship among a decoded signal sequence, sub-band decoded signal sequences and candidate sub-band replication shift signal sequences;

FIG. 19A illustrates a method for generating a 0th sub-band replication shift signal sequence;

FIG. 19B illustrates a method for generating a 1th sub-band replication shift signal sequence;

FIG. 19C illustrates a method for generating a 2th sub-band replication shift signal sequence;

FIG. 19D illustrates a method for generating a 3th sub-band replication shift signal sequence;

FIG. 20A illustrates an exemplary configuration of a coding device of a variation of the third embodiment;

FIG. 20B illustrates an exemplary configuration of a decoding device of the variation of the third embodiment;

FIG. 21A illustrates an exemplary process flow in the coding device of the variation of the third embodiment;

FIG. 21B illustrates an exemplary process flow in the decoding device of the variation of the third embodiment;

FIG. 22A illustrates an exemplary configuration of a coding device of a fourth embodiment;

FIG. 22B illustrates an exemplary configuration of a decoding device of the fourth embodiment;

FIG. 23A illustrates an exemplary configuration of a signal coding part of the fourth embodiment;

FIG. 23B illustrates an exemplary configuration of a signal decoding part of the fourth embodiment;

FIG. 24A illustrates an exemplary configuration of a local decoding coefficient searching part of the fourth embodiment;

FIG. 24B illustrates an exemplary configuration of a local decoding coefficient replicating part of the fourth embodiment;

FIG. 25A illustrates an exemplary process flow in the coding device of the fourth embodiment;

FIG. 25B illustrates an exemplary process flow in the decoding device of the fourth embodiment;

FIG. 26 is a diagram illustrating a method for calculating sub-band bit allocation information;

FIG. 27A illustrates a relationship between bit allocation tables and codebooks in which search ranges do not overlap one another;

FIG. 27B illustrates a relationship between bit allocation tables and codebooks in which search ranges overlap one another;

FIG. 28 is a diagram illustrating a method for selecting a code index;

FIG. 29A illustrates an exemplary configuration of a codling device of a variation of the fourth embodiment;

FIG. 29B illustrates an exemplary configuration of a decoding device of the variation of the fourth embodiment;

FIG. 30A illustrates an exemplary process flow in the coding device of the variation of the fourth embodiment;

FIG. 30B illustrates an exemplary process flow in the decoding device of the variation of the fourth embodiment;

FIG. 31 is a diagram illustrates an exemplary configuration of a coding device of a fifth embodiment and a first variation of the fifth embodiment;

FIG. 32 is a diagram illustrating an exemplary configuration of a decoding device of the fifth embodiment and the first variation of the fifth embodiment;

FIG. 33 is a diagram illustrating an exemplary configuration of a signal coding part of the fifth embodiment;

FIG. 34A illustrates an exemplary configuration of a signal decoding part in the coding device of the fifth embodiment;

FIG. 34B illustrates an exemplary configuration of a signal decoding part in the decoding device of the fifth embodiment;

FIG. 35A illustrates an exemplary process flow in the coding device of the fifth embodiment and the first variation of the fifth embodiment;

FIG. 35B illustrates an exemplary process flow in the decoding device of the fifth embodiment and the first variation of the fifth embodiment;

FIG. 36A illustrates a method for generating a code index;

FIG. 36B illustrates a structure of a dataset;

FIG. 37 is a diagram illustrating an exemplary configuration of a signal coding part of the first variation of the fifth embodiment;

FIG. 38A illustrates an exemplary configuration of a signal decoding part in the coding device of the first variation of the fifth embodiment;

FIG. 38B illustrates an exemplary configuration of a signal decoding part in the decoding device of the first variation of the fifth embodiment;

FIG. 39 is a diagram illustrating a process procedure in a dynamic bit reallocation part 9060;

FIG. 40 is a diagram illustrating an exemplary configuration of a signal coding part of a second variation of the fifth embodiment;

FIG. 41 is a diagram illustrating an exemplary configuration of a signal decoding part of the second variation of the fifth embodiment;

FIG. 42A illustrates an exemplary process flow in a coding device of the second variation of the fifth embodiment;

FIG. 42B illustrates an exemplary process flow in a decoding device of the second variation of the fifth embodiment; and

FIG. 43 is a diagram illustrating an exemplary functional configuration of a computer.

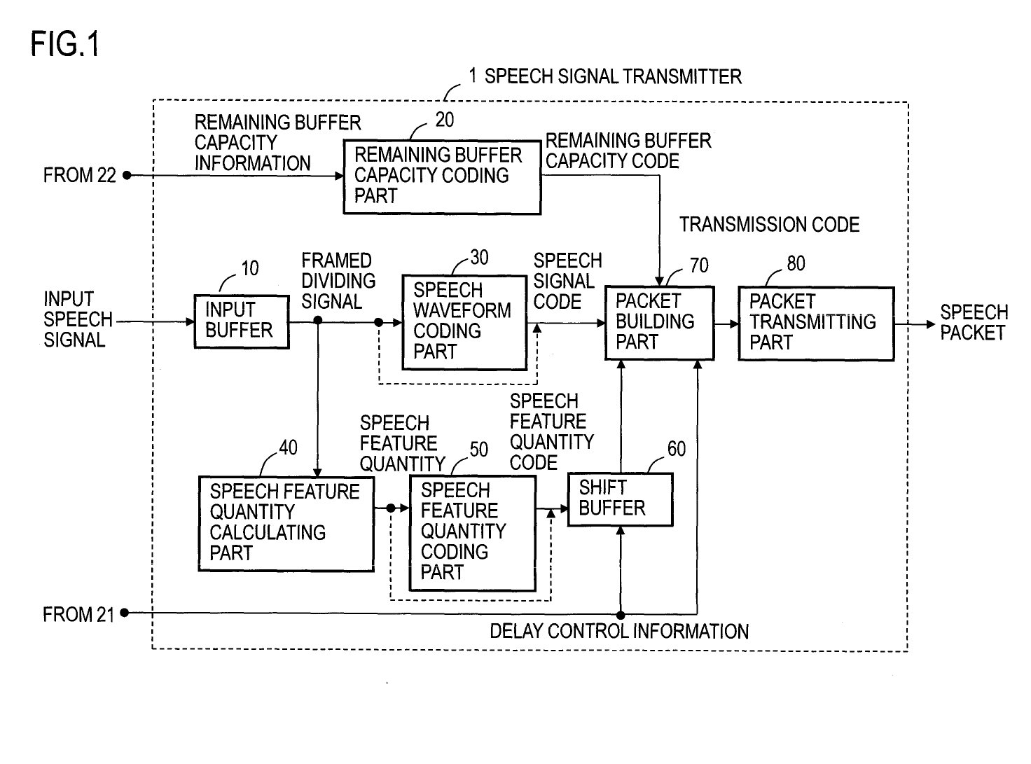

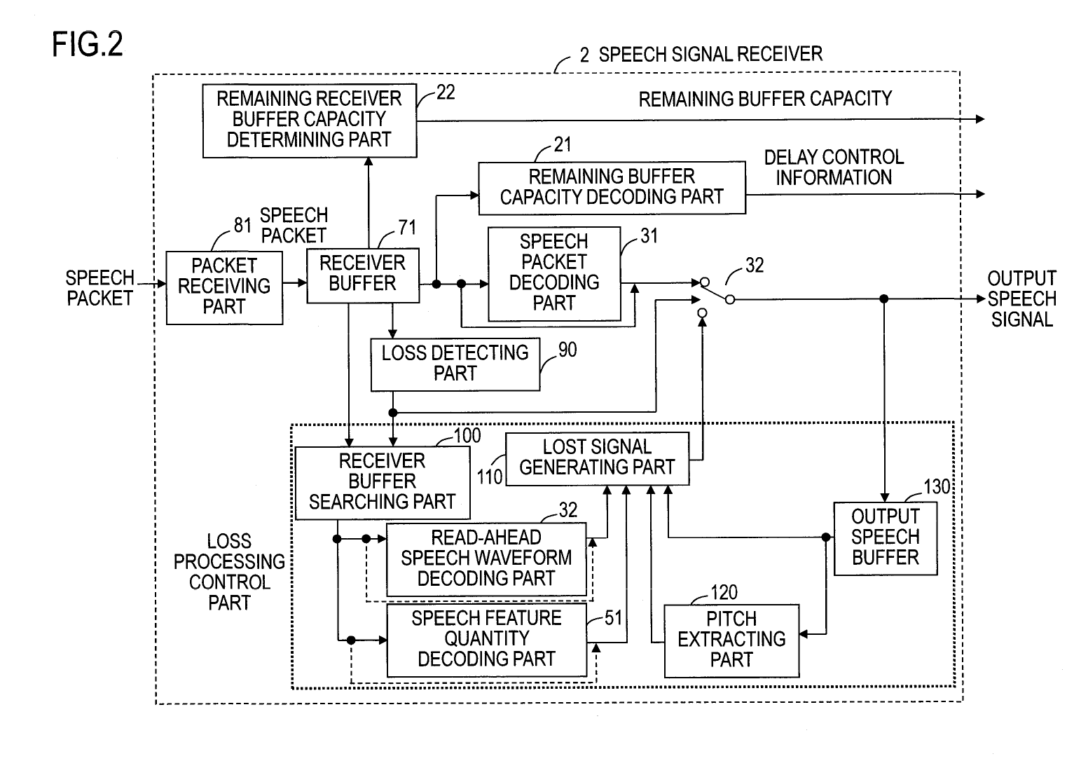

### DETAILED DESCRIPTION OF THE EMBODIMENTS

Embodiments of the present invention will be described below in detail. Like numerals are given to components having like functions and repeated description of those components will be omitted. The term “signal sequence” in the following description refers to one of sets of predetermined number of signals into which a signal is divided for coding and decoding. A signal sequence can be considered a vector having a predetermined number of elements. In this case, the individual signals are considered the elements of the vector. The term “signal(s)” refers to a series of signals not divided into sets of predetermined number of signals or to a single signal.

### First Embodiment

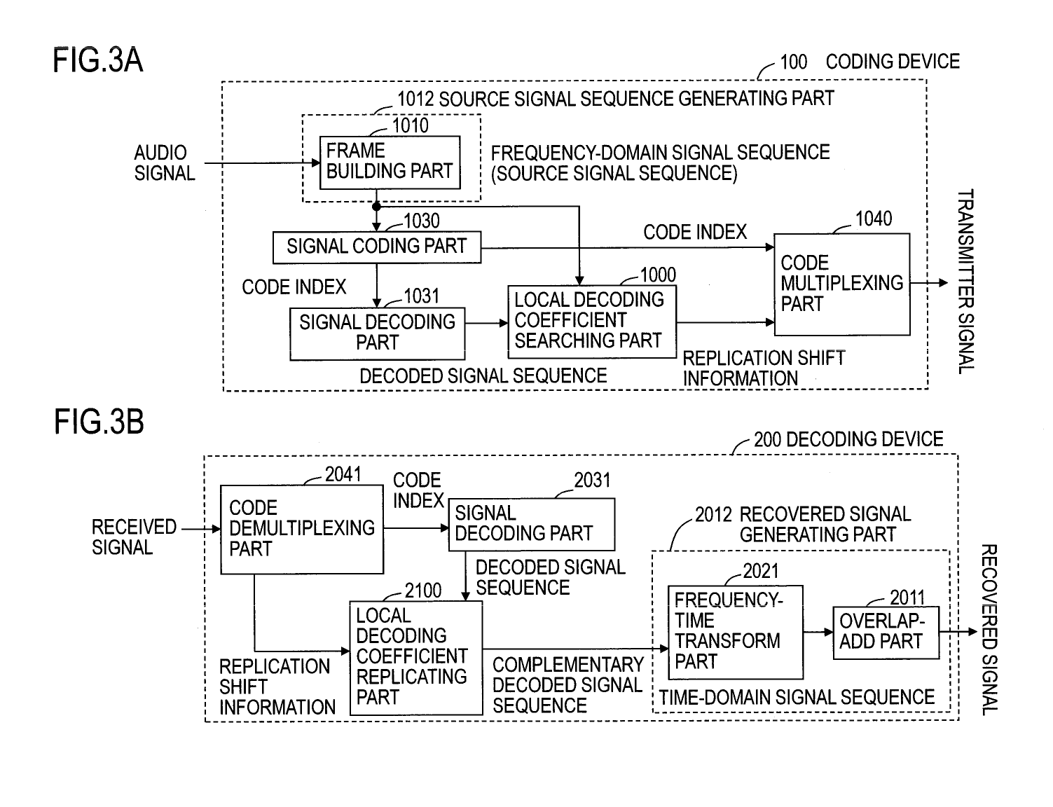

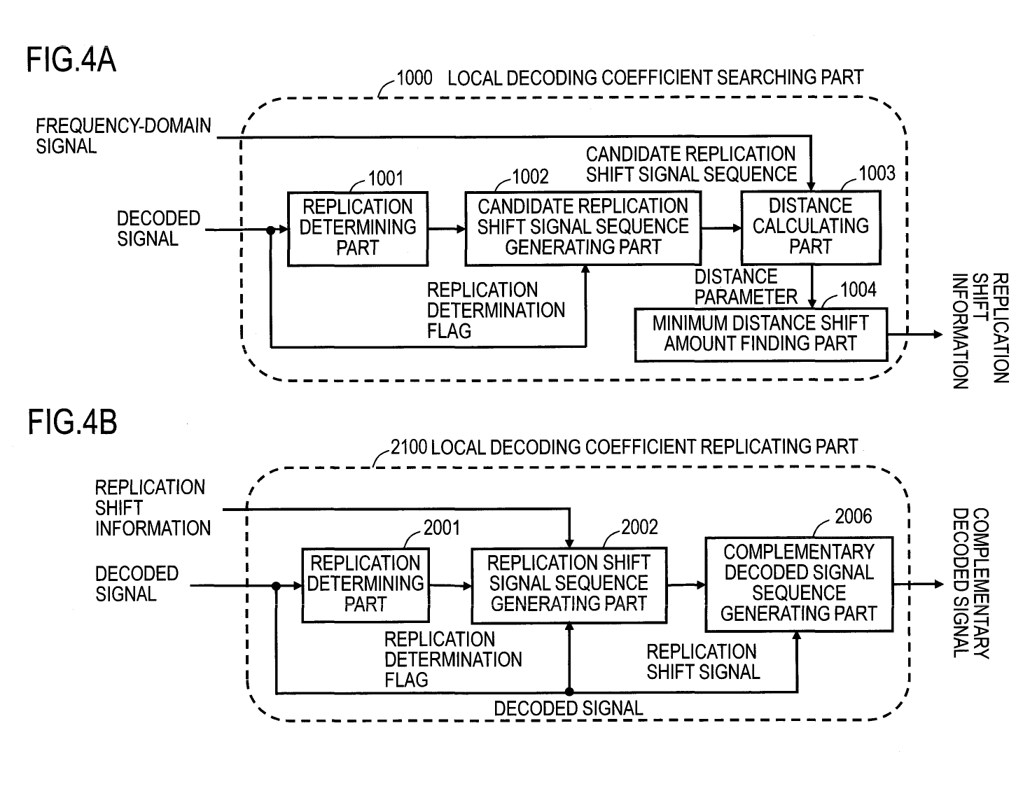

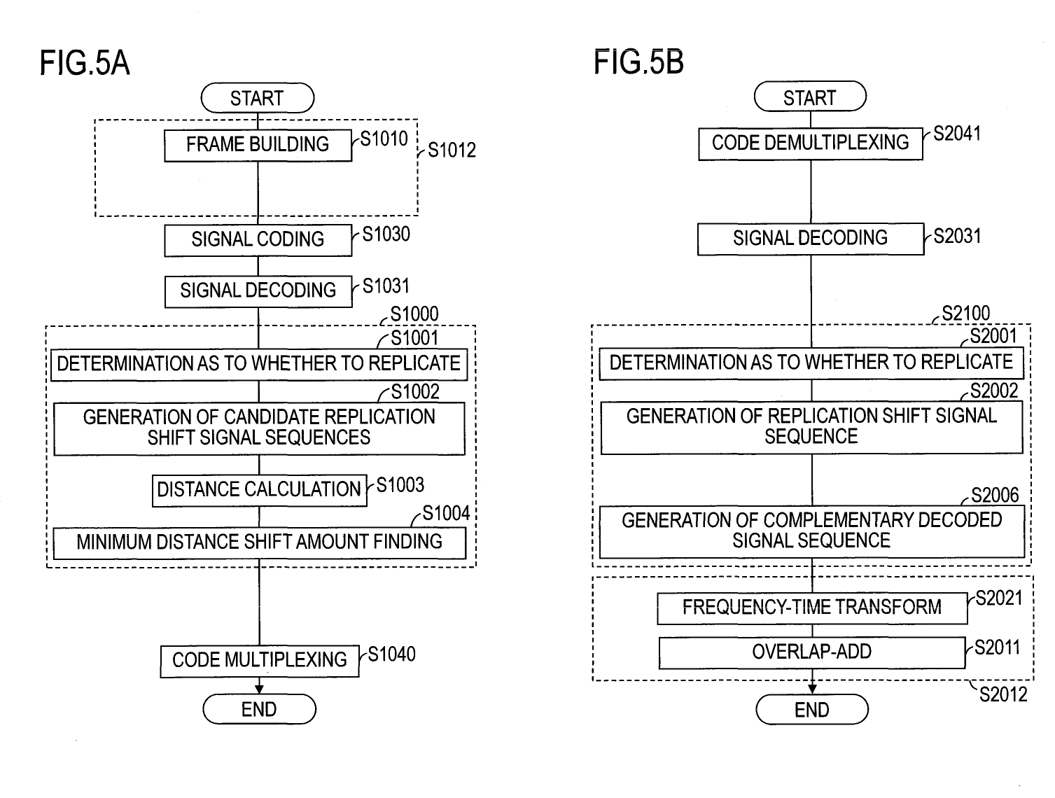

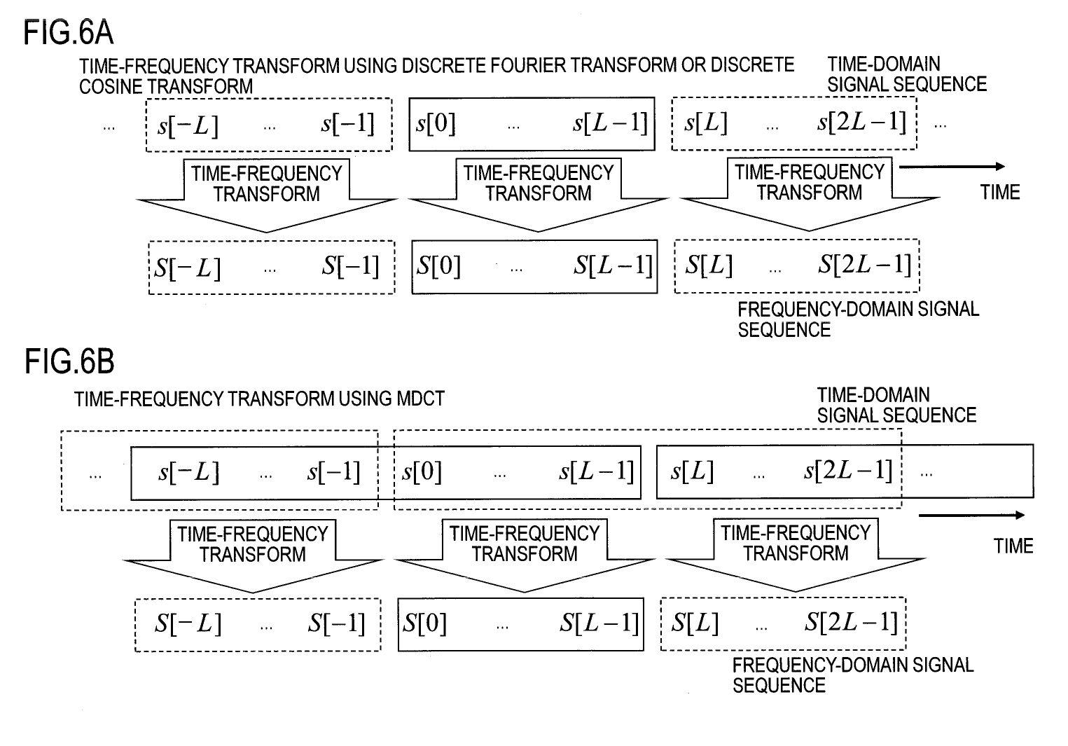

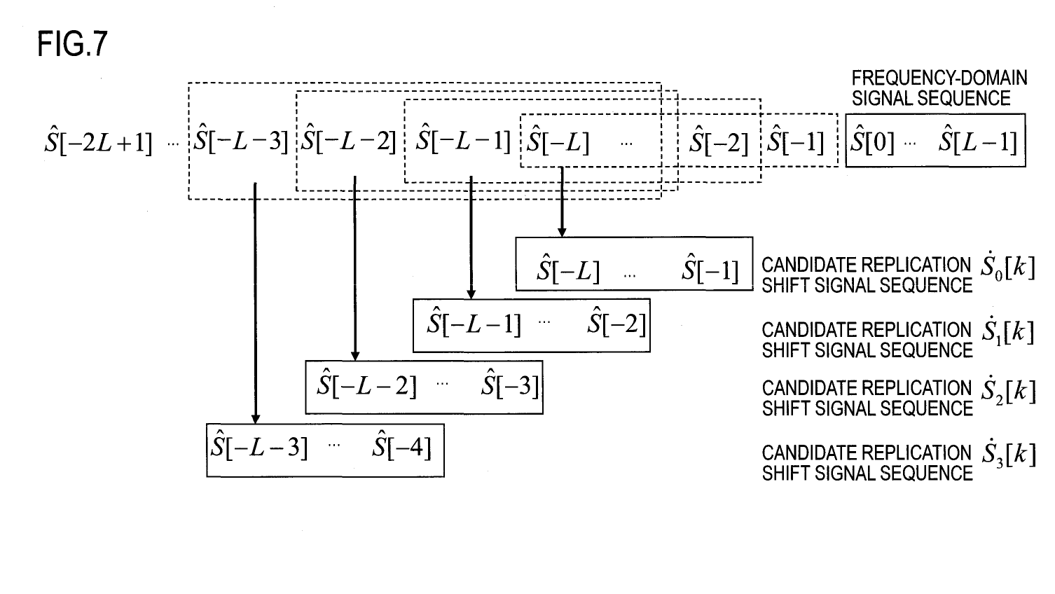

FIGS. 3A, 3B, 4A, 4B, 5A, 5B, 6A, 6B and 7 are diagrams for explaining a first embodiment. FIG. 3A illustrates an exemplary configuration of a coding device and FIG. 3B illustrates an exemplary configuration of a decoding device. FIG. 4A illustrates an exemplary configuration of a local decoding coefficient searching part and FIG. 4B illustrates a local decoding coefficient replicating part. FIG. 5A illustrates an exemplary process flow in the coding device and FIG. 5B illustrates an exemplary process flow in the decoding device. FIGS. 6A and 6B illustrate conceptual diagrams of transformation of a time-domain signal sequence to a frequency-domain signal sequence. FIG. 7 illustrates a method for generating candidate replication shift signal sequences.

Coding Device

The coding device 100 includes a frame building part 1010, a signal coding part 1030, a signal decoding part 1031, a local decoding coefficient searching part 1000, and a code multiplexing part 1040. The frame building part 1010 converts an audio signal captured through a sensor such as a microphone to audio signal samples in digital form and combines a predetermined number L of audio signal samples together to build a frame. The frame building part 1010 applies time-frequency transform to each frame and outputs a frequency-domain signal sequence S[k] (k=0, . . . , L−1) corresponding to the predetermined number L of audio signal samples (S1010). The time-frequency transform may be discrete Fourier transform, discrete cosine transform, or modified discrete cosine transform (MDCT). FIGS. 6A and 6B illustrate conceptual diagrams of the time-frequency transformations. A frequency-domain signal sequence is a signal sequence to be coded (hereinafter referred to as a “source signal sequence”) in the present embodiment. Accordingly, the frame building part 1010 is equivalent to a source signal sequence generating part 1012.

The signal coding part 1030 encodes each source signal sequence and outputs a code index (S1030). For example, the signal coding part 1030 assumes a frequency-domain signal sequence S[k] (k=0, . . . , L−1) to be an L-dimensional vector, performs vector quantization on the frequency-domain signal vector and outputs a code index I_{c}. In the vector quantization, a codevector that is at the minimum distance to the frequency-domain signal vector is selected from the codebook and the index of the selected codevector is output as the code index I_{c}. If Euclidean distance is used as the definition of the parameter representing the distance, a codevector is selected according to Equation (1) given below.

$${I}_{c} = {arg min}_{p} ( {\sum }_{k = 0}^{L - 1} {( S [ k ] - {c}_{k}^{( p )} )}^{2} ) \qquad ( 1 )$$

If the inner product between vectors is used as the definition of the parameter representing the distance, a codevector is selected according to Equation (2).

$${I}_{c} = {arg max}_{p} ( {\sum }_{k = 0}^{L - 1} ( S [ k ] \cdot {c}_{k}^{( p )} ) ) \qquad ( 2 )$$

Here, the pth codevector stored in the codebook is represented by C^{(p)}=(C₀^{(p)}, C₁^{(p)}, . . . , C_{L-1}^{(p)}). Cₖ^{(p)} represents the pth element of the pth vector.

The signal decoding part 1031 decodes the code index and outputs a decoded signal sequence (S1031). For example, the signal decoding part 1031 reads a codevector C^{(c)}=(C₀^{(c)}, C₁^{(c)}, . . . , C_{L-1}^{(c)}) corresponding to the code index I_{c} from the codebook and outputs a decoded signal sequence Ŝ[k] (k=0, . . . , L−1). The decoded signal sequence Ŝ[k] can be obtained by using the codevector C^{(c)} as: Ŝ[0]=C₀^{(c)}, Ŝ[1]=C₁^{(c)}, . . . , Ŝ[L−1]=C_{L-1}^{(c)}.

The local decoding coefficient searching part 1000 outputs a replication shift information τᵣ from a frequency-domain signal sequence S[k], which is the source signal sequence, and the decoded signal sequence Ŝ[k] (S1000). As illustrated in FIG. 4A, the local decoding coefficient searching part 1000 includes a replication determining part 1001, a candidate replication shift signal sequence generating part 1002, a distance calculating part 1003, and a minimum distance shift amount finding part 1004. The replication determining part 1001 determines whether or not a candidate replication shift signal sequence \dot{S}_{τ}[k] (τ=τ₀, . . . , τ_{M}, where M is the number of candidate signal shift amounts τ) is to be generated from the decoded signal sequence Ŝ[k] (k=0, . . . , L−1) and outputs a replication determination flag Flag_{d} (S1001). For example, if the power P of the decoded signal sequence Ŝ[k] is less than or equal to a threshold value, the replication determining part 1001 may output a replication determination flag Flag_{d} indicating that a candidate replication shift signal sequence \dot{S}_{τ}[k] is to be generated (for example Flag_{d}=1); if the power P is greater than the threshold value, the replication determining part 1001 may output a replication determination flag Flag_{d} indicating that a candidate replication shift signal sequence \dot{S}_{τ}[k] is not to be generated (for example Flag_{d}=0). The power of the decoded signal sequence Ŝ[k] (k=0, . . . , L−1) can be calculated according to Equation (3), for example.

P=Σₖ₌₀^{L-1}Ŝ²[k] (3)

The candidate replication shift signal sequence generating part 1002 does not perform processing if the replication determination flag Flag_{d} indicates that a candidate replication shift signal sequence is not to be generated (if Flag_{d}=0). If the replication determination flag Flag_{d} indicates that a candidate replication shift signal sequence is to be generated (if Flag_{d}=1), the candidate replication shift signal sequence generating part 1002 generates a candidate replication shift signal sequence \dot{S}_{τ}[k] for each predetermined candidate signal shift amount τ=τ₀, . . . , τ_{M} (S1002). For example, a candidate replication shift signal sequence \dot{S}_{τ}[k] may be obtained as:

\dot{S}_{τ}[k]=Ŝ[−L−τ+k]

### (see FIG. 7).

The distance calculating part 1003 calculates a parameter representing the distance between each candidate replication shift signal sequence \dot{S}_{τ}[k] and the frequency-domain signal sequence S[k] (hereinafter referred to as the “distance parameter”) (S1003). The distance parameter may be calculated using a method such as those given below. Each signal sequence may be considered a vector and d[τ] (τ=τ₀, . . . , τ_{M}), which is a distance parameter between two vectors, may be calculated according to Equation (4) or (5). Equation (4) represents the Euclidean distance and Equation (5) represents the inner product. However, the equation for calculating the distance parameter is not limited to these equations.

d[τ]=Σₖ₌₀^{L-1}(S[k]−\dot{S}_{τ[k}])² (4)

d[τ]=Σₖ₌₀^{L-1}(S[k]·\dot{S}_{τ}[k]) (5)

If the distance parameter is calculated according to Equation (4), the minimum distance shift amount finding part 1004 obtains a signal shift amount τ that minimizes the distance parameter d[τ] and outputs the signal shift amount τ as replication shift information τᵣ (S1004). Specifically, the replication shift information τᵣ is obtained according to Equation (6).

$${τ}_{r} = {arg min}_{τ = \{ {τ}_{0} … {τ}_{L - 1} \}} d [ τ ] \qquad ( 6 )$$

If the distance parameter is calculated according to Equation (5), the minimum distance shift amount finding part 1004 obtains a signal shift amount τ that maximizes the distance parameter d[τ] and outputs the signal shift amount τ as replication shift information τᵣ (S1004). Specifically, the replication shift information τᵣ is obtained according to Equation (7).

$${τ}_{r} = {arg max}_{τ = \{ {τ}_{0} … {τ}_{L - 1} \}} d [ τ ] \qquad ( 7 )$$

The code multiplexing part 1040 multiplexes code indices I_{c} and replication shift information τᵣ to generate a transmitter signal (S1040). Specifically, the code multiplexing part 1040 receives code indices I_{c} and replication shift information τᵣ as inputs and arranges them in a predetermined order to generate one dataset. If the signal is transmitted through a network such as an IP network, the code multiplexing part 1040 adds required header information to generate packets.

Decoding Device

The decoding device 200 includes a code demultiplexing part 2041, a signal decoding part 2031, a local decoding coefficient replicating part 2100, a frequency-time transform part 2021, and an overlap-add part 2011. The combination of the frequency-time transform part 2021 and the overlap-add part 2011 will be referred to as a recovered signal generating part 2012. The code demultiplexing part 2041 reads a code index I_{c} and replication shift information τᵣ from a received signal and outputs them (S2041). The signal decoding part 2031 decodes the code index I_{c} and outputs a decoded signal sequence Ŝ[k] (k=0, . . . , L−1) (S2031).

The local decoding coefficient replicating part 2100 generates a complementary decoded signal sequence S^{˜}[k] (k=0, . . . , L−1) from the decoded signal sequence Ŝ[k] and the replication shift information τᵣ (S2100). As illustrated in FIG. 4B, the local decoding coefficient replicating part 2100 includes a replication determining part 2001, a replication shift signal sequence generating part 2002, and a complementary decoded signal sequence generating part 2006. The replication determining part 2001 determines whether or not a replication shift signal sequence Ŝ_{τ}[k] is to be generated from the decoded signal sequence Ŝ[k] and outputs a replication determination flag Flag_{d} (S2001). The process performed by the replication determining part 2001 is the same as that performed by the replication determining part 1001 of the coding device 100.

If the replication determination flag Flag_{d} indicates that a candidate replication shift signal sequence is to be generated (if Flag_{d}=1), the replication shift signal sequence generating part 2002 generates a replication shift signal sequence \dot{S}_{τ}[k] on the basis of the shift amount τ indicated by the replication shift information τᵣ (S2002). For example, the candidate replication shift signal sequence \dot{S}_{τ}[k] may be obtained from the decoded signal sequence Ŝ[k] and the shift amount τ indicated by the replication shift information as:

\dot{S}_{τ}[k]=Ŝ[−L−τ+k]

If the replication determination flag Flag_{d} indicates that a candidate replication shift signal sequence is to be generated (if Flag_{d}=1), the complementary decoded signal sequence generating part 2006 sets the replication shift signal sequence \dot{S}[k] as a complementary decoded signal sequence \tilde{S}[k] and outputs the complementary decode signal \tilde{S}[k] (S2006), if the replication determination flag Flag_{d} indicates that a candidate replication shift signal sequence is not to be generated (if Flag_{d}=0), the complementary decoded signal sequence generating part 2006 sets the decoded signal sequence Ŝ[k] as a complementary decoded signal sequence \tilde{S}[k] and outputs the complementary decoded signal sequence \tilde{S}[k] (S2006). Specifically, one of the following equations

$$\tilde{S} [ k ] = \{ \begin{matrix}{\dot{S}}_{τ} [ k ] ( k = 0 , … , L - 1 ) & ( when {Flag}_{d} = 1 ) \\ \hat{S} [ k ] ( k = 0 , … , L - 1 ) & ( when {Flag}_{d} = 0 )\end{matrix} \qquad ( 8 )$$

is used to obtain a complementary decoded signal sequence \tilde{S}[k].

The recovered signal generating part 2012 generates a recovered signal, which is a signal representing original audio information, from the complementary decoded signal sequence \tilde{S}[k] (S2012). In the present embodiment, the source signal sequence is a frequency-domain signal sequence S[k]. That is, the complementary decoded signal sequence \tilde{S}[k] is a signal in frequency domain. The recovered signal generating part 2012 therefore includes the frequency-time transform part 2021 and the overlap-add part 2011. The frequency-time transform part 2021 transforms the frequency-domain signal sequence S[k] to a time-domain signal sequence including L samples (S2021). The overlap-add part 2011 overlaps a half of each frame length of a signal obtained by multiplying the time-domain signal sequence by a window function with a half of the next frame and adds the overlapped portions together to calculate a recovered signal and provides the recovered signal (S2011).

The coding device and the decoding device of the first embodiment reduce coding distortion and auditory noise by shifting a decoded signal in time domain or frequency domain and copying or adding the signal resulted from the shifting to the decoded signal. Accordingly, auditory noise can be reduced and a decoded signal with improved subjective quality can be provided using only a small number of bits.

### [Variation]

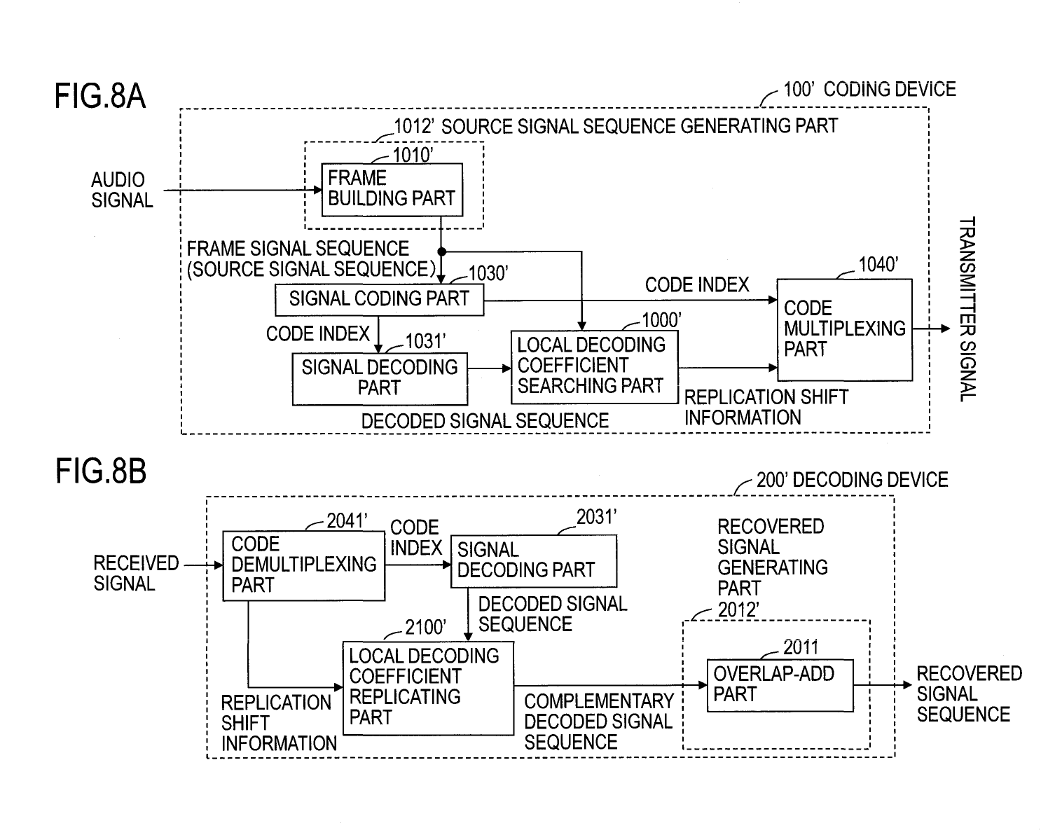

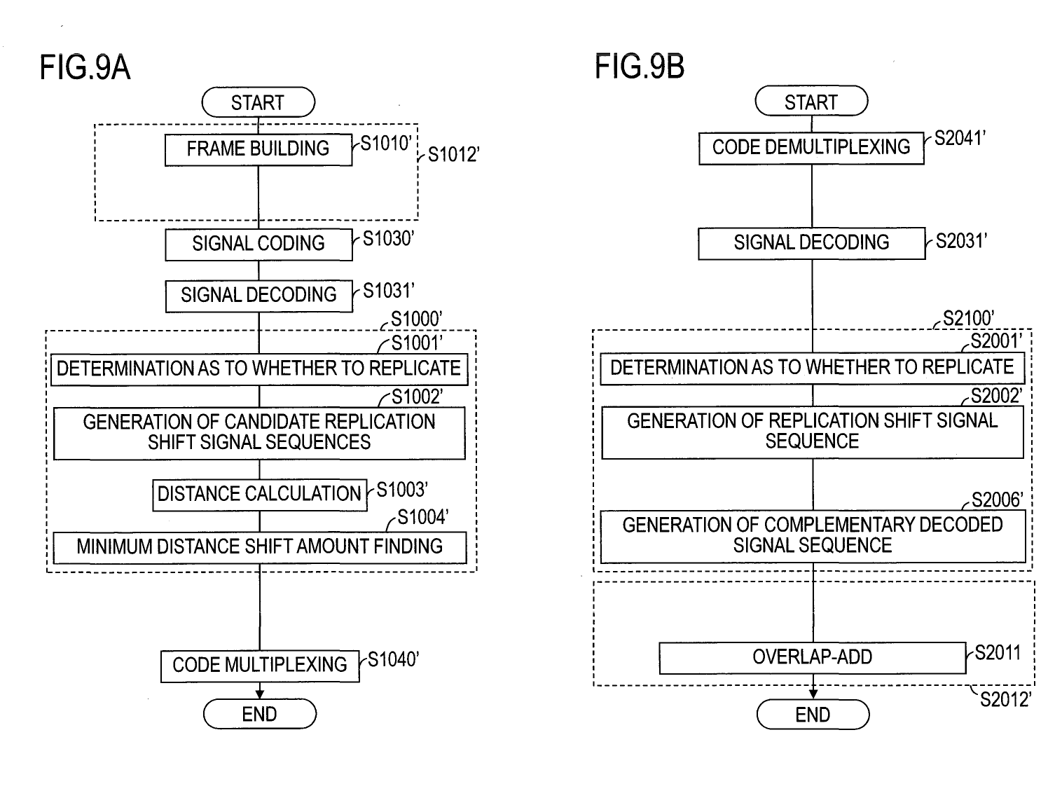

FIGS. 8A, 8B, 9A and 9B illustrate functional configurations and process flows in a variation in which the source signal sequences are time-domain signal sequences in frames. FIG. 8A illustrates an exemplary functional configuration of a coding device and FIG. 8B illustrates an exemplary functional configuration of a decoding device. FIG. 9A illustrates an exemplary process flow in the coding device and FIG. 9B illustrates an exemplary process flow in the decoding device.

The coding device 100′ and the decoding device 200′ are similar to the coding device 100 and the decoding device 200, respectively, with the only difference being signal sequences to be coded. Therefore, only the processes performed by a source signal sequence generating part 1012′ and a recovered signal generating part 2012′ are different from those in the coding device 100 and the decoding device 200.

The source signal sequence generating part 1012′ is formed by a frame building part 1010′. The frame building part 1010′ converts an audio signal captured through a sensor such as a microphone to audio signal samples in digital form and combines a predetermined number L of audio signal samples together to build a frame. The frame building part 1010′ outputs signal sequences s[k] (k=0, . . . , L−1) in frames (hereinafter referred to as “frame signal sequences”) (S1010′). The processes performed by the other components of the coding device 100′ are the same as those of the coding device 100.

In the decoding device 200′, a complementary decoded signal sequence \tilde{s}[k] (k=0, . . . , L−1) corresponds to a frame signal sequence s[k]. That is, a complementary decoded signal sequence \tilde{s}[k] in the variation is a time-domain signal sequence. Accordingly, the recovered signal generating part 2012′ does not require a frequency-time transform part and includes only an overlap-add part 2011. The overlap-add part 2011 overlaps a half of each frame length of a signal obtained by multiplying the time-domain signal sequence by a window function with a half of the next frame and adds the overlapped portions together to calculate a recovered signal and provides the recovered signal (S2011).

With the configuration described above, the coding device and the decoding device of the variation have the same effects as the coding and decoding devices of the first embodiment.

### Second Embodiment

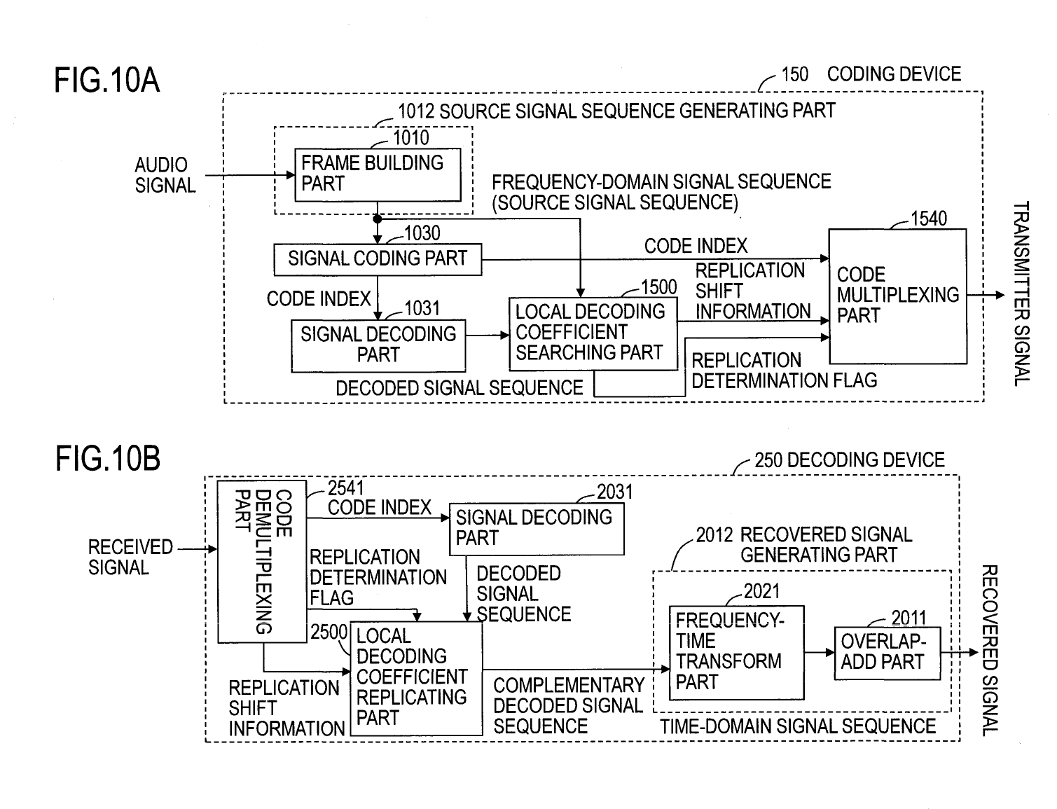

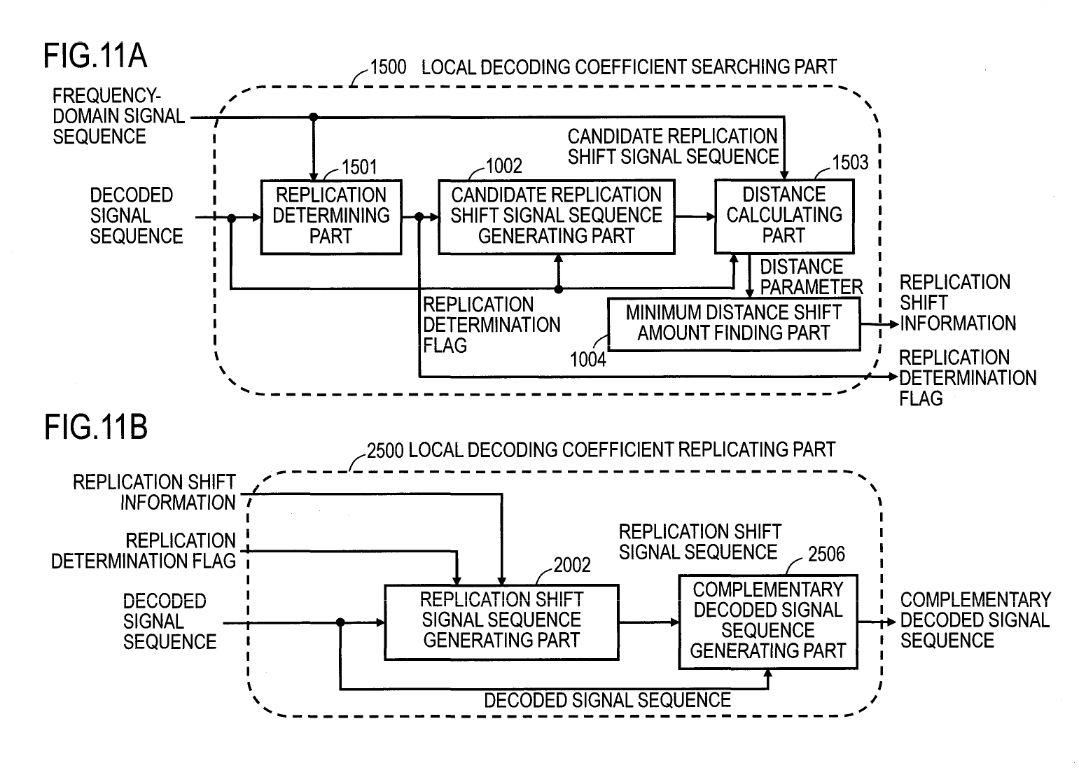

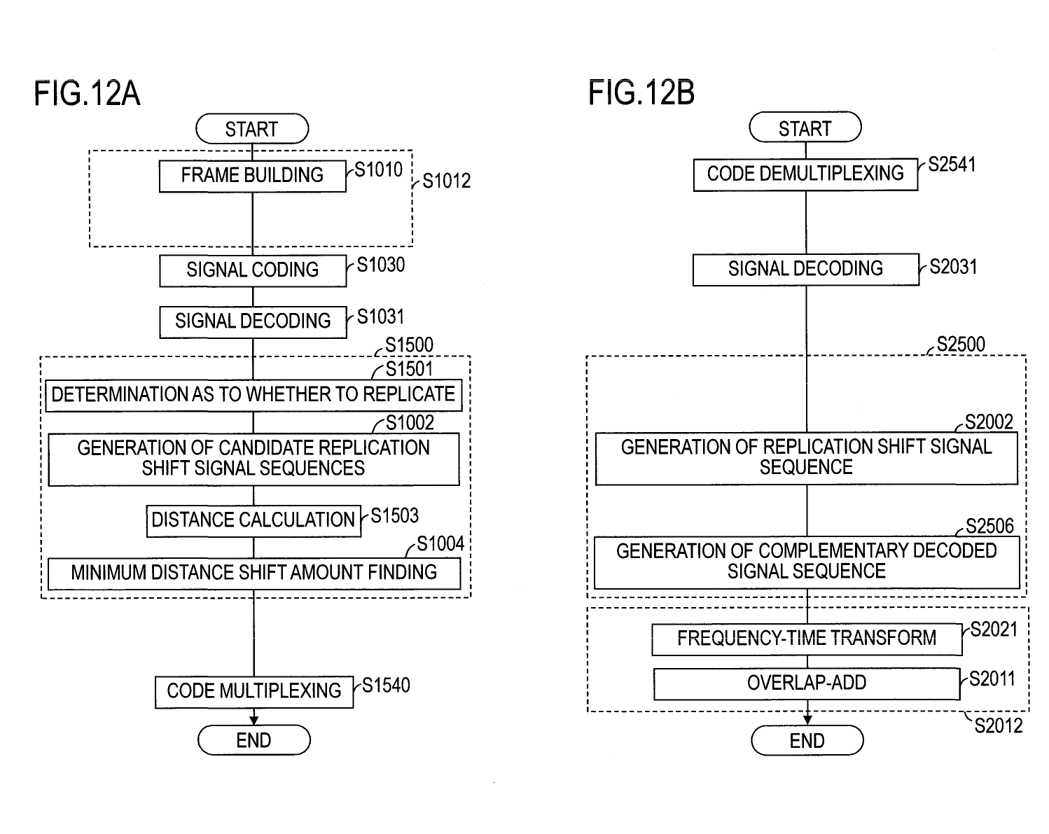

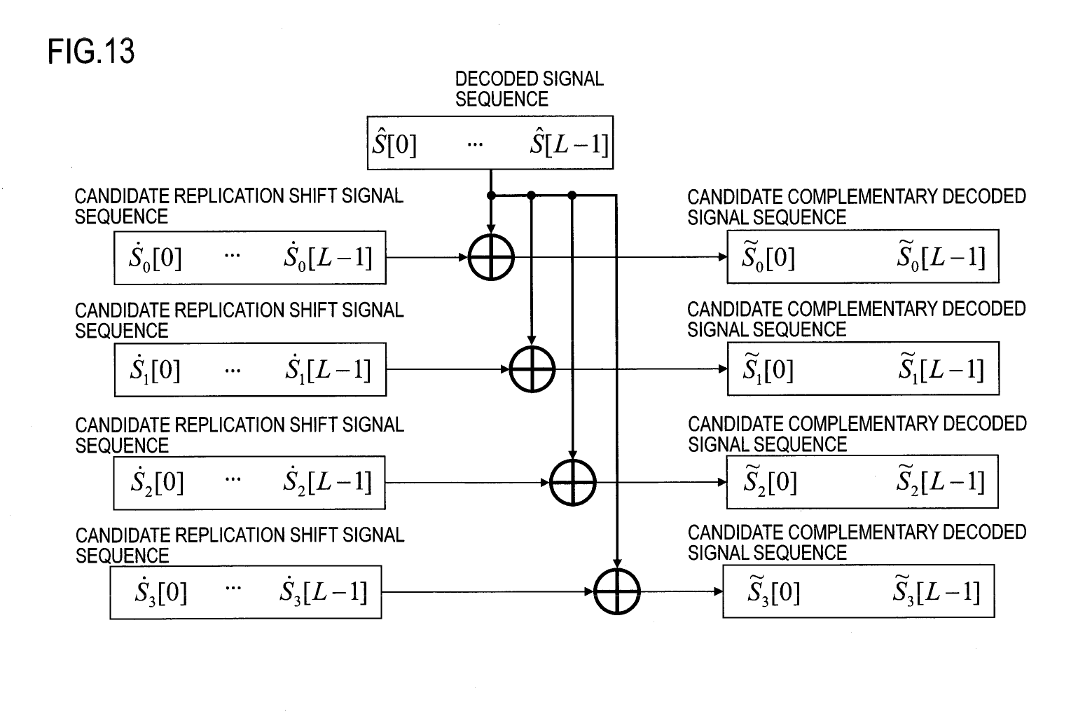

FIGS. 10A, 10B, 11A, 11B, 12A, 12B and 13 are diagrams for explaining a second embodiment. FIG. 10A illustrates an exemplary configuration of a coding device and FIG. 10B illustrates an exemplary configuration of a decoding device. FIG. 11A illustrates an exemplary configuration of a local decoding coefficient searching part and FIG. 11B illustrates an exemplary configuration of a local decoding coefficient replicating part. FIG. 12A illustrates an exemplary process flow in the coding device and FIG. 12B illustrates an exemplary process flow in the decoding device. FIG. 13 illustrates a method for generating candidate complementary decoded signal sequences. Source signal sequences in the second embodiment are the same frequency-domain signal sequences (as in the first embodiment).

Coding Device

The coding device 150 includes a frame building part 1010, a signal coding part 1030, a signal decoding part 1031, a local decoding coefficient searching part 1500, and a code multiplexing part 1540. The frame building part 1010, the signal coding part 1030 and the signal decoding part 1031 are the same as those of the coding device 100 of the first embodiment.

The local decoding coefficient searching part 1500 outputs replication shift information τᵣ and a replication determination flag Flag_{d} from a frequency-domain signal sequence S[k], which is a source signal sequence to be coded, and a decoded signal sequence Ŝ[k] (S1500). As illustrated in FIG. 11A, the local decoding coefficient searching part 1500 includes a replication determining part 1501, a candidate replication shift signal sequence generating part 1002, a distance calculating part 1503, and a minimum distance shift amount finding part 1004. The replication determining part 1501 determines from the power of a difference signal between the frequency-domain signal sequence S[k] (k=0, . . . , L−1) and the decoded signal sequences Ŝ[k] (k=0, . . . , L−1) whether or not a candidate replication shift signal sequence \dot{S}_{τ}[k](τ=τ₀, . . . , τ_{M}, where M is the number of candidate signal shift amounts τ) is to be generated and outputs a replication determination flag Flag_{d} (S1501). For example, if the power P of the difference signal (S[k]−Ŝ[k]) between the frequency-domain signal sequence S[k] and the decoded signal sequence Ŝ[k] exceeds a threshold value, the replication determining part 1501 may output a replication determination flag Flag_{d} indicating that a candidate replication shift signal sequence \dot{S}_{τ}[k] is to be generated (for example Flag_{d}=1); if the power P is less than or equal to the threshold value, the replication determining part 1501 may output a replication determination flag Flag_{d} indicating that a candidate replication shift signal sequence \dot{S}_{τ}[k] is not to be generated (for example Flag_{d}=0). The power of the difference signal (S[k]−Ŝ[k]) may be calculated according to Equation (9), for example.

P=Σₖ₌₀^{L-1}(S[k]−Ŝ[k])² (9)

The candidate replication shift signal sequence generating part 1002 is the same as that of the first embodiment. The distance calculating part 1503 adds the candidate replication shift signal sequence and the decoded signal sequence Ŝ[k] to obtain a candidate complementary decoded signal sequence \tilde{S}^{τ}[k] and calculates a parameter representing the distance between the candidate complementary decoded signal sequence \tilde{S}_{τ}[k] and the frequency-domain signal sequence S[k] (S1503). The distance parameter may be calculated using a method such as those given below. Each signal sequence may be considered a vector and d[τ] (τ=τ₀, . . . , τ_{M}), which is a distance parameter between two vectors, may be calculated according to Equation (10) or (11). Equation (10) represents the Euclidean distance and Equation (11) represents the inner product. However, the equation for calculating the distance parameter is not limited to these equations.

$$\begin{matrix}\begin{matrix}d [ τ ] = {\sum }_{k = 0}^{L - 1} {( S [ k ] - {\tilde{S}}_{τ} [ k ] )}^{2} \\ = {\sum }_{k = 0}^{L - 1} {( S [ k ] - \hat{S} [ k ] - {\dot{S}}_{τ} [ k ] )}^{2}\end{matrix} & ( 10 ) \\ \begin{matrix}d [ τ ] = {\sum }_{k = 0}^{L - 1} ( S [ k ] \cdot {\tilde{S}}_{τ} [ k ] ) \\ = {\sum }_{k = 0}^{L - 1} S [ k ] \cdot ( \hat{S} [ k ] + {\dot{S}}_{τ} [ k ] )\end{matrix} & ( 11 )\end{matrix}$$

The minimum distance shift amount finding part 1004 is the same as that of the first embodiment.

The code multiplexing part 1540 multiplexes code indices replication shift information τᵣ and replication determination flags Flag_{d} to generate a transmitter signal (S1040). Specifically, the code multiplexing part 1540 receives code indices I_{C}, replication shift information τᵣ and replication determination flags Flag_{d} as inputs and arranges them in a predetermined order to generate one dataset. If the signal is transmitted through a network such as an IP network, the code multiplexing part 1540 adds required header information to generate packets.

Decoding Device

A decoding device 250 includes a code demultiplexing part 2541, a signal decoding part 2031, a local decoding coefficient replicating part 2500, a frequency-time transform part 2021, and an overlap-add part 2011. The combination of the frequency-time transform part 2021 and the overlap-add part 2011 will be referred to as a recovered signal generating part 2012. The code demultiplexing part 2541 reads a code index I_{c}, replication shift information τᵣ and replication determination flag Flag_{d} from a received signal and outputs them (S2541). The signal decoding part 2031 is the same as that of the first embodiment.

The local decoding coefficient replicating part 2500 generates a complementary decoded signal sequence \tilde{S}[k] (k=0, . . . , L−1) from a decoded signal sequence Ŝ[k], the replication shift information τᵣ, and the replication determination flag Flag_{d} (S2500). As illustrated in FIG. 11B, the local decoding coefficient replicating part 2500 includes a replication shift signal sequence generating part 2002 and a complementary decoded signal sequence generating part 2506. The embodiment does not require a replication determining part because the replication determination flag Flag_{d} is contained in the received signal. The replication shift signal sequence generating part 2002 is the same as that of the first embodiment.

As illustrated in FIG. 13, the complementary decoded signal sequence generating part 2506 adds replication shift signal sequences \dot{S}_{τ}[k] and the decoded signal sequence Ŝ[k] to generate complementary decoded signal sequences \tilde{S}[k] and outputs the complementary decoded signal sequences \tilde{S}[k] (S2006). Specifically,

\tilde{S}[k]=Ŝ[k]+\dot{S}_{τ}[k] (k=0, . . . , L−1) (12)

is calculated to obtain the complementary decoded signal sequences \tilde{S}[k].

The recovered signal generating part 2012 is the same as that of the first embodiment.

With the configuration described above, coding distortion due to a large difference between a source signal sequence and a decoded signal sequence can be reduced.

### Third Embodiment

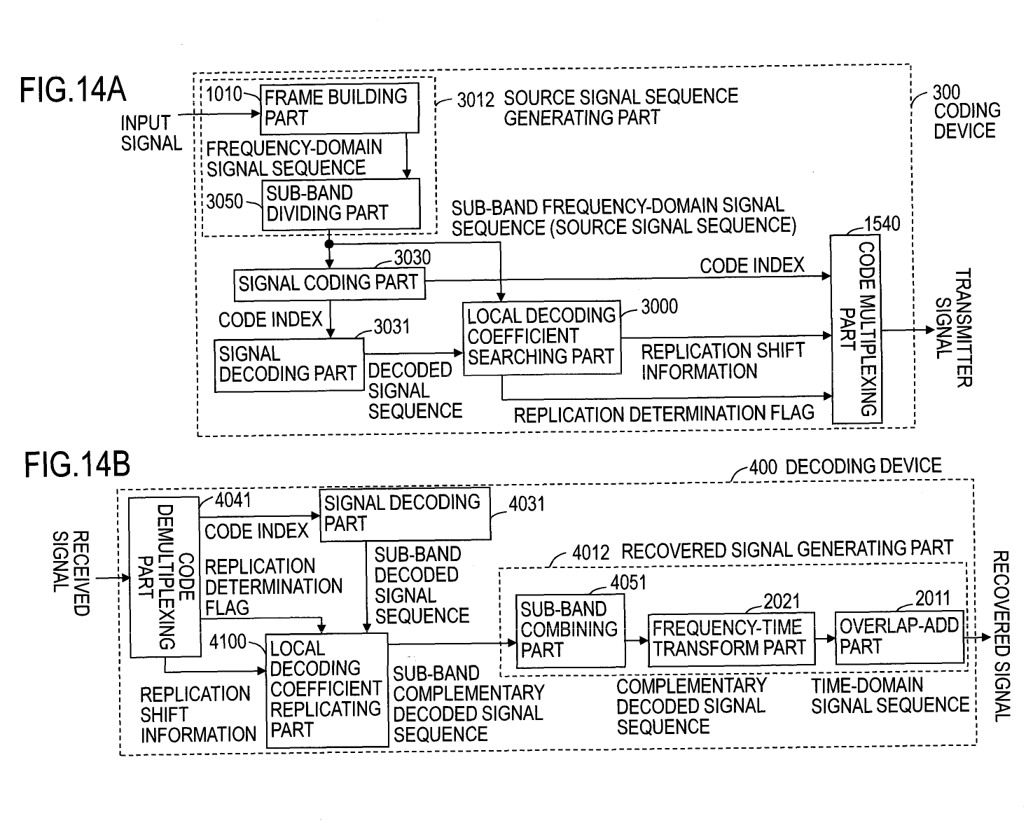

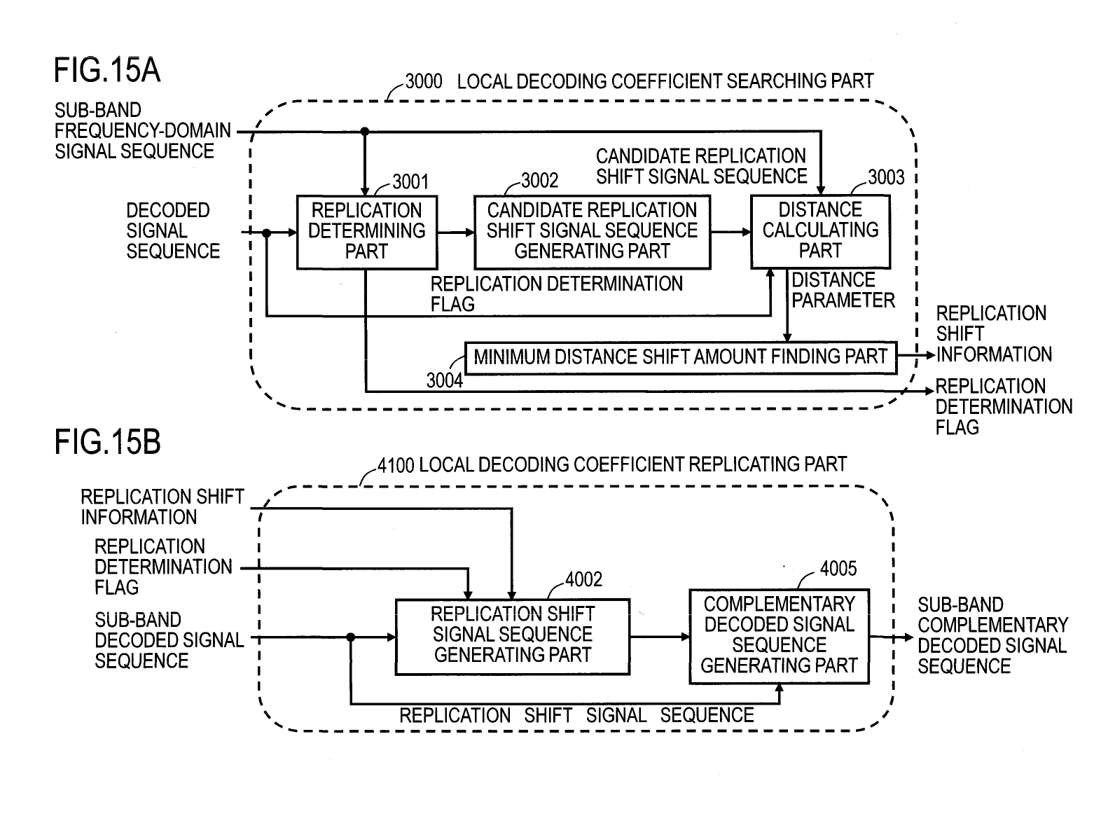

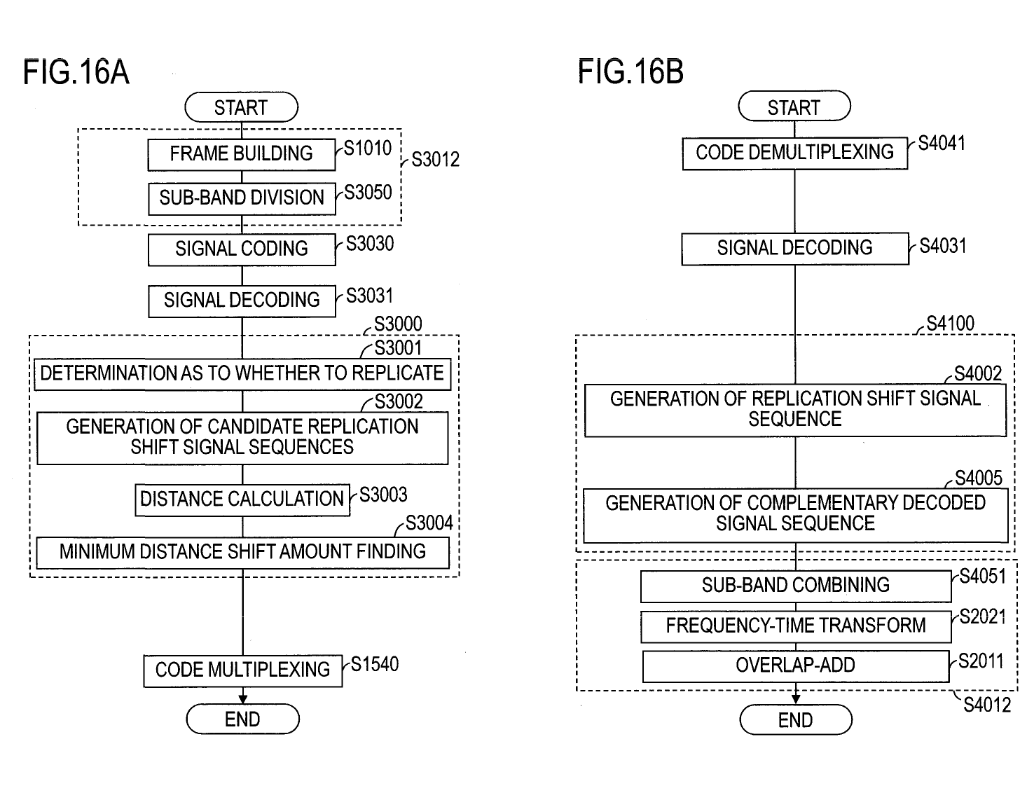

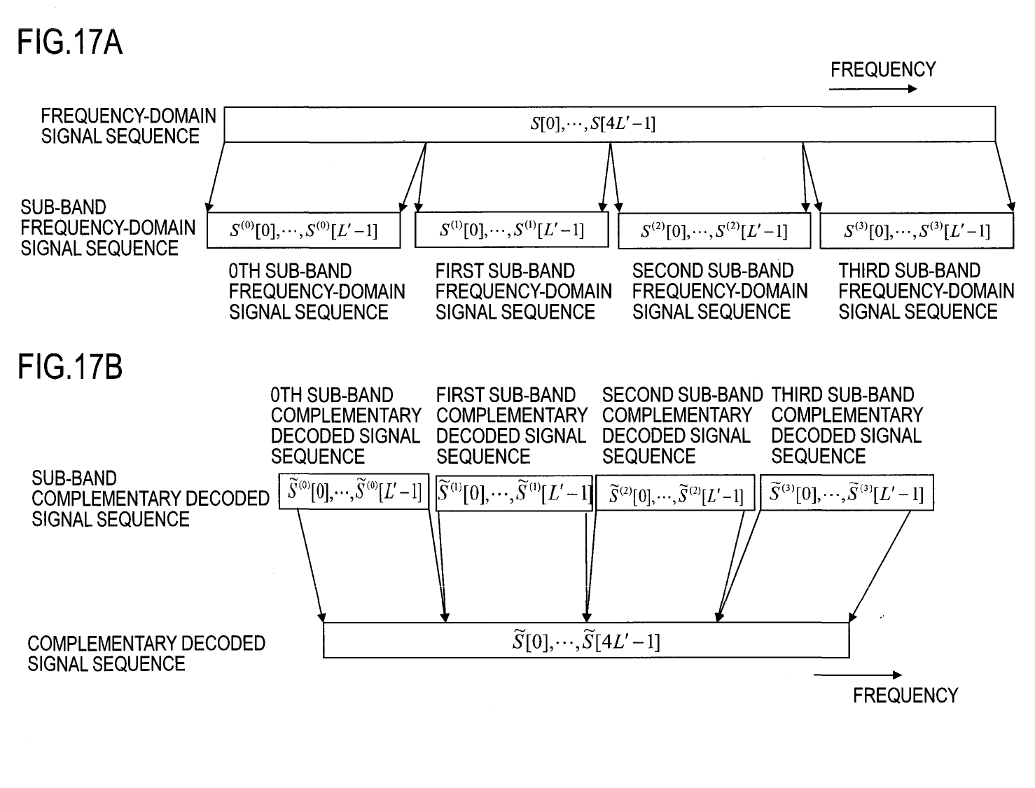

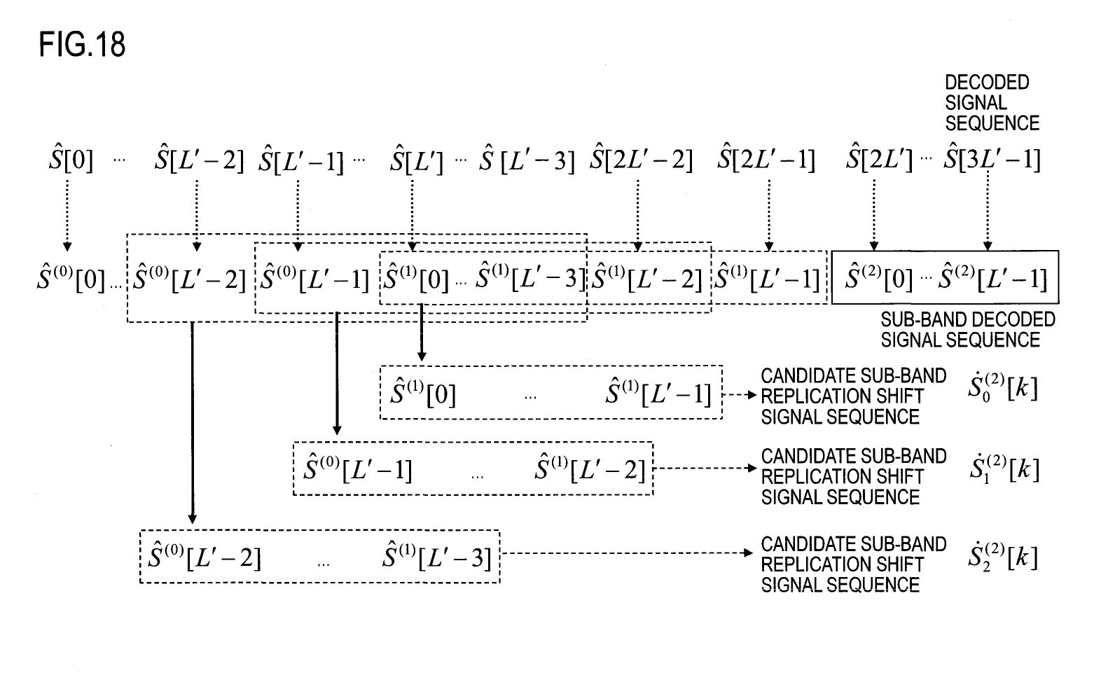

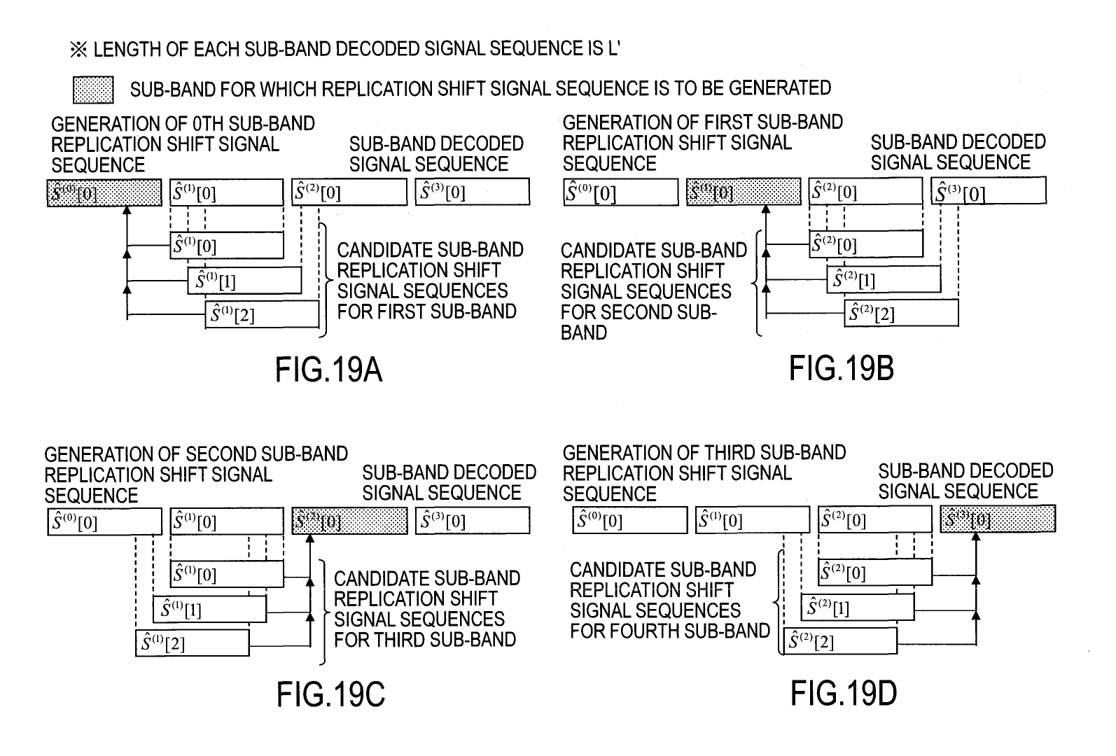

FIGS. 14A, 14B, 15A, 15B, 16A, 16B, 17A, 17B, 18, 19A, 19B, 19C and 19D are diagrams for explaining a third embodiment. FIG. 14A illustrates an exemplary configuration of a coding device. FIG. 14B illustrates an exemplary configuration of a decoding device. FIG. 15A illustrates an exemplary configuration of a local decoding coefficient searching part and FIG. 15B illustrates an exemplary configuration of a local decoding coefficient replicating part. FIG. 16A illustrates an exemplary process flow in the coding device and FIG. 16B illustrates an exemplary process flow in the decoding device. FIG. 17A is a conceptual diagram of transformation of a frequency-domain signal sequence to sub-band frequency-domain signal sequences and FIG. 17B is a conceptual diagram of transformation of sub-band complementary decoded signal sequences to a complementary decoded signal sequence. FIG. 18 illustrates relationship among a decoded signal sequence, sub-band decoded signal sequences and candidate sub-band replication shift signal sequences. FIGS. 19A, 19B, 19C and 19D illustrate methods for generating sub-band replication shift signal sequences. The embodiment differs from the second embodiment in that a frequency-domain signal sequence is divided into sub-band signal sequences according to frequency bands and the sub-band signal sequences are used as source signal sequences to be coded.

Coding Device

The coding device 300 includes a frame building part 1010, a band dividing part 3050, a signal coding part 3030, a signal decoding part 3031, a local decoding coefficient searching part 3000, and a code multiplexing part 1540. The frame building part 1010 and the code multiplexing part 1540 are the same as those of the coding device 150 of the second embodiment. The band dividing part 3050 divides a frequency-domain signal sequence S[k] (k=0, . . . , L−1) into multiple sub-band frequency-domain signal sequences S^{(w)}[k] (w=0, . . . , W−1 and k=0, . . . , L′−1) as illustrated in FIG. 17A (S3050). Here, W represents the number of sub-band frequency-domain signal sequences into which the frequency-domain signal sequence is divided and L′ represents the number of signals contained in a sub-band frequency-domain signal sequence. In the example in FIG. 17A, W=4 and L=4L′. In the following description, a sub-band frequency-domain signal sequence S^{(w)}[k] is called the “wth sub-band frequency-domain signal sequence” when it is necessary to indicate what number in order the signal sequence S^{(w)}[k] is, or is simply called “sub-band frequency-domain signal sequence” when it is unnecessary to identify what number in order the signal sequence S^{(w)}[k] is. In this embodiment, the sub-band frequency-domain signal sequences are source signal sequences to be coded.

The signal coding part 3030 performs processing similar to the processing by the signal coding part 1030 of the first embodiment, with the only difference being that sub-band frequency-domain signal sequences are coded instead of frequency-domain signal sequences. The signal coding part 3030 outputs code indices I_{C}^{(w)} for the sub-band frequency-domain signal sequences S^{(w)}[k] (S3030).

The signal decoding part 3031 performs the processing similar to the processing by the signal decoding part 1031 of the first embodiment with the only difference being that sub-band frequency-domain signal sequences are coded for the code indices I_{c}^{(w)} instead of frequency-domain signal sequences. The signal decoding part 3031 outputs decoded signal sequences Ŝ^{(w)}[k] (w=0, . . . , W−1 and k=0, . . . , L′−1) (S3031).

The local decoding coefficient searching part 3000 outputs replication shift information τᵣ^{(w)} and replication determination flags Flag_{d}^{(w)} from the sub-band frequency-domain signal sequence S^{(w)}[k] and the decoded signal sequence Ŝ^{(w)}[k] (S3000). As illustrated in FIG. 15A, the local decoding coefficient searching part 3000 includes a replication determining part 3001, a candidate replication shift signal sequence generating part 3002, a distance calculating part 3003, and a minimum distance shift amount finding part 3004.

The replication determining part 3001 is similar to that of the second embodiment, with the only difference being the number of signals contained in a source signal sequence. Specifically, the replication determining part 3001 determines whether or not a candidate replication shift signal sequence \dot{S}_{τ}^{(w)}[k](τ=τ₀, . . . , τ_{M}, where M is the number of candidate signal shift amounts τ) is to be generated from the power of a difference signal between the sub-band frequency-domain signal sequence S^{(W)}[k] and the decoded signal sequence Ŝ^{(w)}[k] and outputs a replication determination flag Flag_{d}^{(w)} (S3001). For example, if the power P of the difference signal (S^{(w)}[k]−Ŝ^{(w)}[k]) between the sub-band frequency-domain signal sequence S^{(w)[k] and a decoded signal sequence Ŝ}^{(w)}[k] exceeds a threshold value, the replication determining part 3001 may output a replication determination flag Flag_{d}^{(w)} indicating that a candidate replication shift signal sequence \dot{S}_{τ}^{(w)}[k] is to be generated (for example Flag_{d}^{(w)}=1); if the power P is less than or equal to the threshold value, the replication determining part 3001 may output a replication determination flag Flag_{d}^{(w)} indicating that a candidate replication shift signal sequence \dot{S}_{τ}^{(w)}[k] is not to be generated (for example Flag_{d}^{(w)}=0). The power of the difference signal (S^{(w)}[k]−Ŝ^{(w)}[k]) may be calculated according to Equation (9), for example.

P=Σₖ₌₀^{L-1}(S^{(w)}[k]−Ŝ^{(w)}[k])² (13)

If the replication determination flag Flag_{d}^{(w)} indicates that a candidate replication shift signal sequence is not to be generated (when Flag_{d}^{(w)}=0), the candidate replication shift signal sequence generating part 3002 does not perform processing. If the replication determination flag Flag_{d}^{(w)} indicates that a candidate replication shift signal sequence is to be generated (when Flagd^{(w)}=1), the candidate replication shift signal sequence generating part 3002 generates a candidate replication shift signal sequence \dot{S}_{τ}^{(w)}[k] for each predetermined candidate signal shift amount τ=τ₀, . . . , τ_{M} (S3002). For example, candidate sub-band replication shift signal sequences \dot{S}^{(w)}[k] are generated from decoded signal sequences of the neighboring sub-bands as:

$${\dot{S}}_{τ}^{( w )} [ k ] = \{ \begin{matrix}{\hat{S}}^{( w + 1 )} [ k + {τ}_{r}^{( w )} ] & ( \begin{matrix}when w = 0 or 1 , and \\ 0 \leq k \leq {L}^{′} - {τ}_{r}^{( w )} - 1\end{matrix} ) \\ {\hat{S}}^{( w + 2 )} [ k - {L}^{′} + {τ}_{r}^{( w )} ] & ( \begin{matrix}when w = 0 or 1 , and \\ {L}^{′} - {τ}_{r}^{( w )} \leq k \leq {L}^{′} - 1\end{matrix} ) \\ {\hat{S}}^{( w - 2 )} [ k + {L}^{′} - {τ}_{r}^{( w )} ] & ( \begin{matrix}when w > 1 , and \\ 0 \leq k \leq {τ}_{r}^{( w )} - 1\end{matrix} ) \\ {\hat{S}}^{( w - 1 )} [ k - {τ}_{r}^{( w )} ] & ( \begin{matrix}when w > 1 , and \\ {τ}_{r}^{( w )} \leq k \leq {L}^{′} - 1\end{matrix} )\end{matrix} \qquad ( 14 )$$

According to Equation (14), candidate replication shift signal sequences \dot{S}_{τ}^{(w)}[k] are generated from decoded signal sequences corresponding to sub-band frequency-domain signal sequences provided by dividing the same original frequency-domain signal sequence. Because sub-band frequency-domain signal sequences provided by dividing the same frequency-domain signal sequence generally have a strong correlation to one another, candidate sub-band replication shift signal sequences \dot{S}_{τ}^{(w)}[k] close in distance can be obtained. FIG. 18 illustrates an example of generation of \dot{S}_{τ}⁽²⁾[k].

The distance calculating part 3003 and the minimum distance shift amount finding part 3004 are similar to those of the first and second embodiments, with the only difference being the number of signals in a signal sequence. The code multiplexing part 1540 is the same as that of the second embodiment.

Decoding Device

The decoding device 400 includes a code demultiplexing part 4041, a signal decoding part 4031, a local decoding coefficient replicating part 4100, a sub-band combining part 4051, a frequency-time transform part 2021, and an overlap-add part 2011. The combination of the sub-band combining part 4051, the frequency-time transform part 2021 and the overlap-add part 2011 will be referred to as a recovered signal generating part 4012. The code demultiplexing part 4041 reads code indices I_{c}^{(w)}, replication shift information τᵣ^{(w)} and replication determination flags Flag_{d}^{(w)} from a received signal and outputs them (S4041). The signal decoding part 4031 decodes the code indices I_{c}(w) and outputs sub-band decoded signal sequences Ŝ^{(w)}[k] (k=0, . . . , L−1) (S4031).

The local decoding coefficient replicating part 4100 generates sub-band complementary decoded signal sequences \tilde{S}^{(w)}[k] (k=0, . . . , L−1) from the sub-band decoded signal sequences Ŝ^{(w)}[k], the replication shift information τᵣ^{(w)} and the replication determination flags Flagd^{(w)} (S4100). As illustrated in FIG. 15B, the local decoding coefficient replicating part 4100 includes a replication shift signal sequence generating part 4002 and a complementary decoded signal sequence generating part 4005.

The replication shift signal sequence generating part 4002 outputs sub-band replication shift signal sequences \dot{S}[k] (w=0, . . . , W−1 and k=0, . . . , L′−1) in the same way as the candidate replication shift signal sequence generating part 3002 does (S4002). For example, if the candidate replication shift signal sequence generating part 3002 has generated candidate replication shift signal sequences \dot{S}_{τ}^{(w)}[k] according to Equation (14), the replication shift signal sequence generating part 4002 may generate the sub-band replication shift signal sequences \dot{S}^{(w)}[k] according to Equation (15).

$${\dot{S}}^{( w )} [ k ] = \{ \begin{matrix}{\hat{S}}^{( w + 1 )} [ k + {τ}_{r}^{( w )} ] & ( \begin{matrix}when w = 0 or 1 , and \\ 0 \leq k \leq {L}^{′} - {τ}_{r}^{( w )} - 1\end{matrix} ) \\ {\hat{S}}^{( w + 2 )} [ k - {L}^{′} + {τ}_{r}^{( w )} ] & ( \begin{matrix}when w = 0 or 1 , and \\ {L}^{′} - {τ}_{r}^{( w )} \leq k \leq {L}^{′} - 1\end{matrix} ) \\ {\hat{S}}^{( w - 2 )} [ k + {L}^{′} - {τ}_{r}^{( w )} ] & ( \begin{matrix}when w > 1 , and \\ 0 \leq k \leq {τ}_{r}^{( w )} - 1\end{matrix} ) \\ {\hat{S}}^{( w - 1 )} [ k - {τ}_{r}^{( w )} ] & ( \begin{matrix}when w > 1 , and \\ {τ}_{r}^{( w )} \leq k \leq {L}^{′} - 1\end{matrix} )\end{matrix} \qquad ( 15 )$$

FIGS. 19A, 19B, 19C and 19D illustrate the operation according to Equation (15).

The complementary decoded signal sequence generating part 4005 adds the sub-band replication shift signal sequence \dot{S}^{(w)}[k] and the decoded signal sequence Ŝ^{(w)}[k] to generate and output a sub-band complementary decoded signal sequence \tilde{S}^{(w)}[k] (S4005).

The sub-band combining part 4051 combines sub-band complementary decoded signal sequences to generate a complementary decoded signal sequence as illustrated in FIG. 17B (S4051). The frequency-time transform part 2021 and the overlap-add part 2011 are the same as those of the first and second embodiments.

With the configuration described above, the coding device and the decoding device of the third embodiment have the same effects as the coding and decoding devices of the first and second embodiments. In addition, the coding and decoding device of the third embodiment can further reduce auditory noise because they can reduce errors in frequency bands in which high distortion is caused by coding.

[Variation]

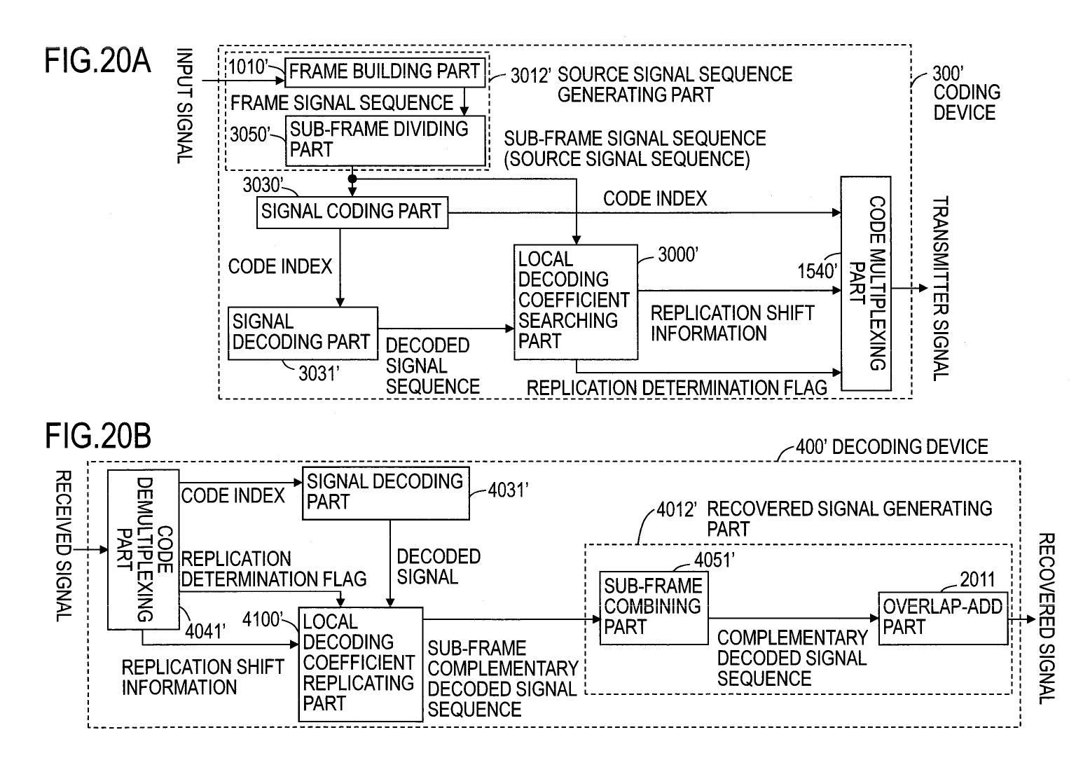

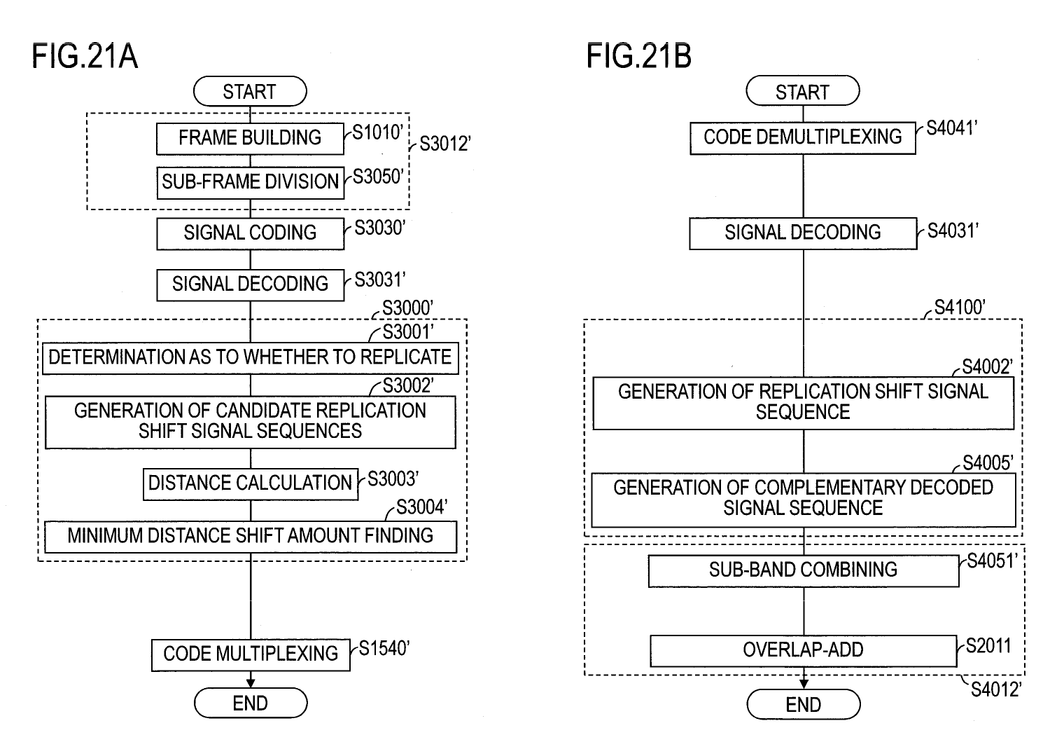

FIGS. 20A, 20B, 21A and 21B illustrate functional configurations and process flows in a variation in which source signal sequences to be coded are time-domain signal sequences in sub-frames. FIG. 20A illustrates an exemplary functional configuration of a coding device and FIG. 20B illustrates an exemplary functional configuration of a decoding device. FIG. 21A illustrates an exemplary process flow in the coding device and FIG. 21B illustrates an exemplary process flow in the decoding device.

The coding device 300′ and the decoding device 400′ are similar to the coding device 300 and the decoding device 400, respectively, with the only difference being source signal sequences. Accordingly, only processes performed by the source signal sequence generating part 3012′ and the recovered signal generating part 4012′ differ from those in the coding and decoding devices 300 and 400.

The source signal sequence generating part 3012′ includes a frame building part 1010′ and a frame dividing part 3050′. The frame building part 1010 converts an audio signal captured through a sensor such as a microphone to audio signal samples in digital form and combines a predetermined number L of audio signal samples into a frame. The frame building part 1010′ outputs signal sequences s[k] (k=0, . . . , L−1) in frames (hereinafter referred to as “frame signal sequences”) (S1010′). The frame dividing part 3050′ divides a frame signal sequence into sub-frame signal sequences s^{(w)}[k] (w=0, . . . , W−1 and k=0, . . . , L′−1) (S3050′). The processes performed by the other components of the coding device 300′ are the same as those in the coding device 300.

In the decoding device 400′, a complementary sub-frame decoded signal sequence \tilde{s}^{(w)}[k] (w=0, . . . , W−1 and k=0, . . . , L′−1) corresponds to a sub-frame signal sequence s^{(w)}[k]. That is, a complementary sub-frame decoded signal sequence \tilde{s}^{(w)}[k] in the variation is a time-domain signal sequence. Accordingly, the recovered signal generating part 4012′ does not require a frequency-time transform part and includes only a sub-frame combining part 4051′ and an overlap-add part 2011. The sub-frame combining part 4051′ combines the complementary sub-frame decoded signal sequences \tilde{s}^{(w)}[k] to generate a complementary decoded signal sequence \tilde{s}[k] (S4051′). The overlap-add part 2011 overlaps a half of each frame length of a signal obtained by multiplying the complementary decoded signal sequence \tilde{s}[k] by a window function with a half of the next frame and adds the overlapped portions together to calculate a recovered signal and provides the recovered signal (S2011).

With the configuration described above, the coding device and the decoding device of the variation have the same effects as the coding and decoding devices of the third embodiments.

### Fourth Embodiment

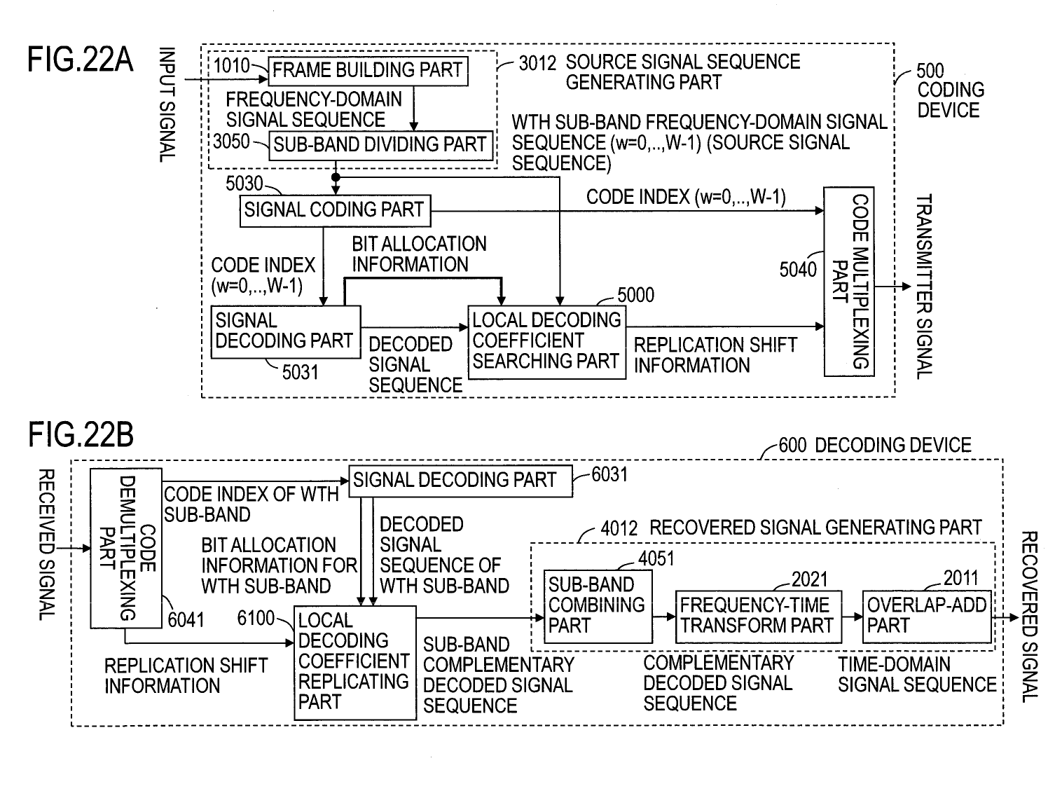

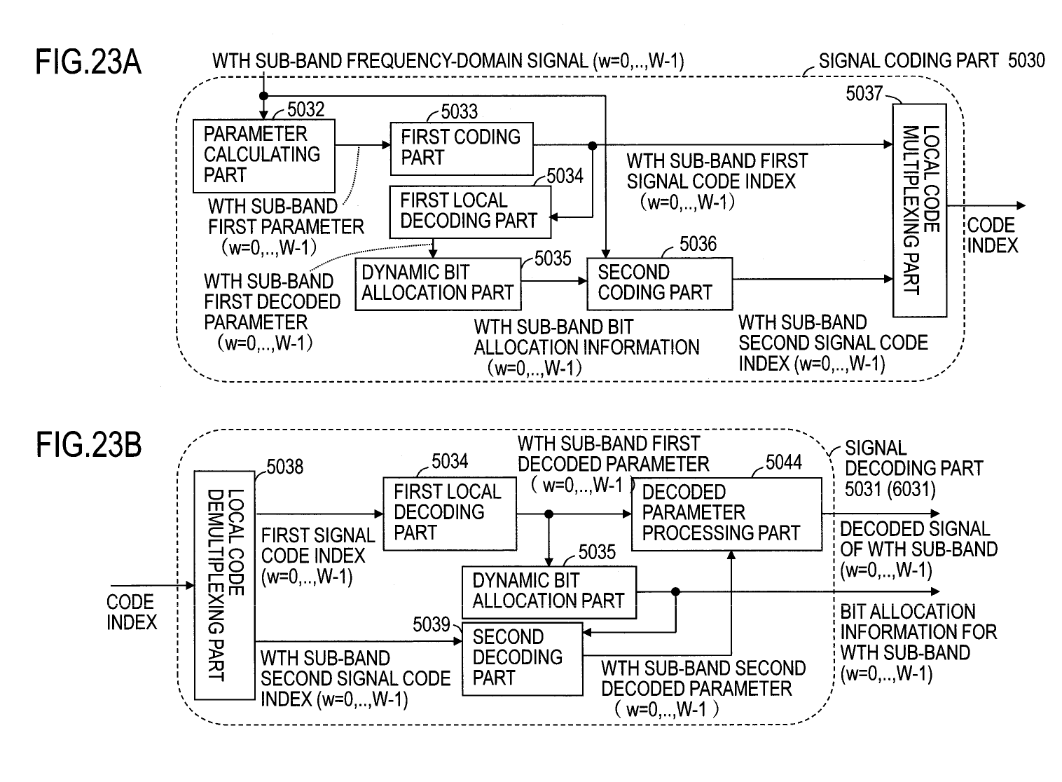

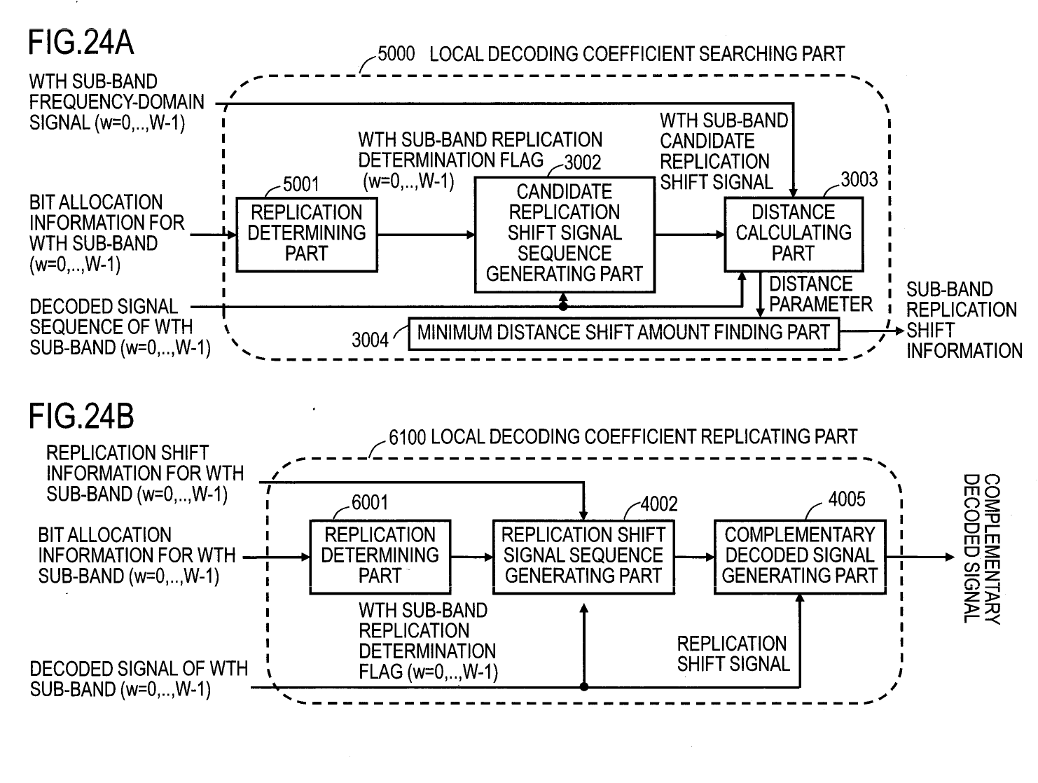

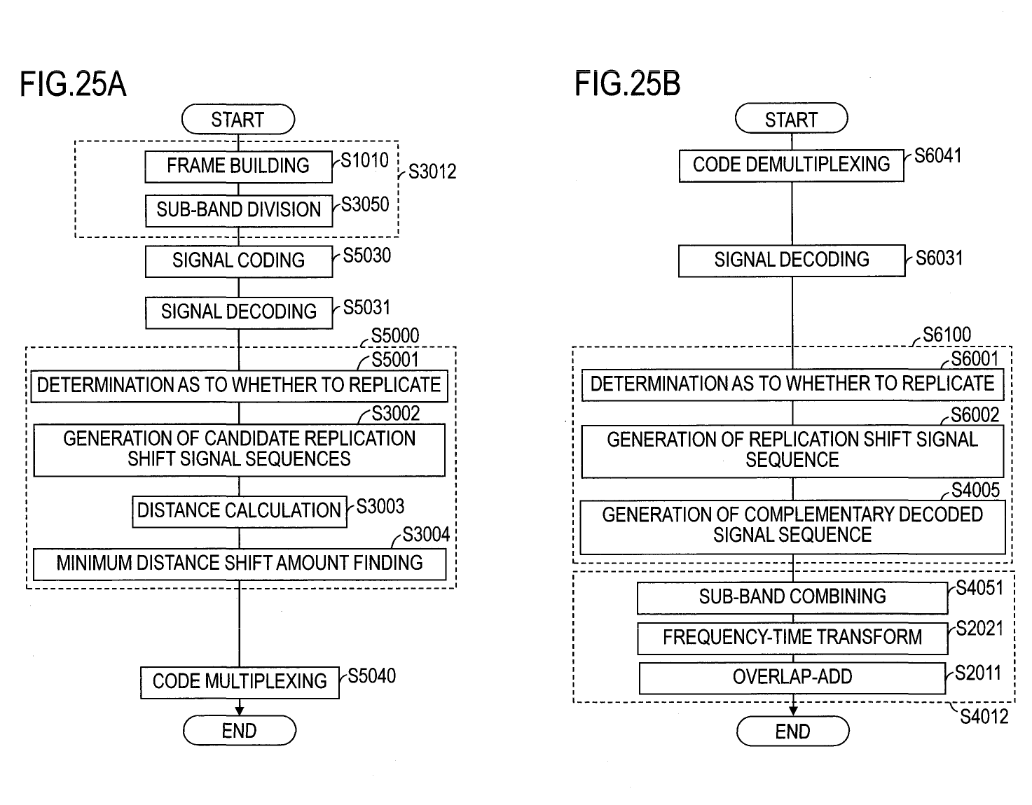

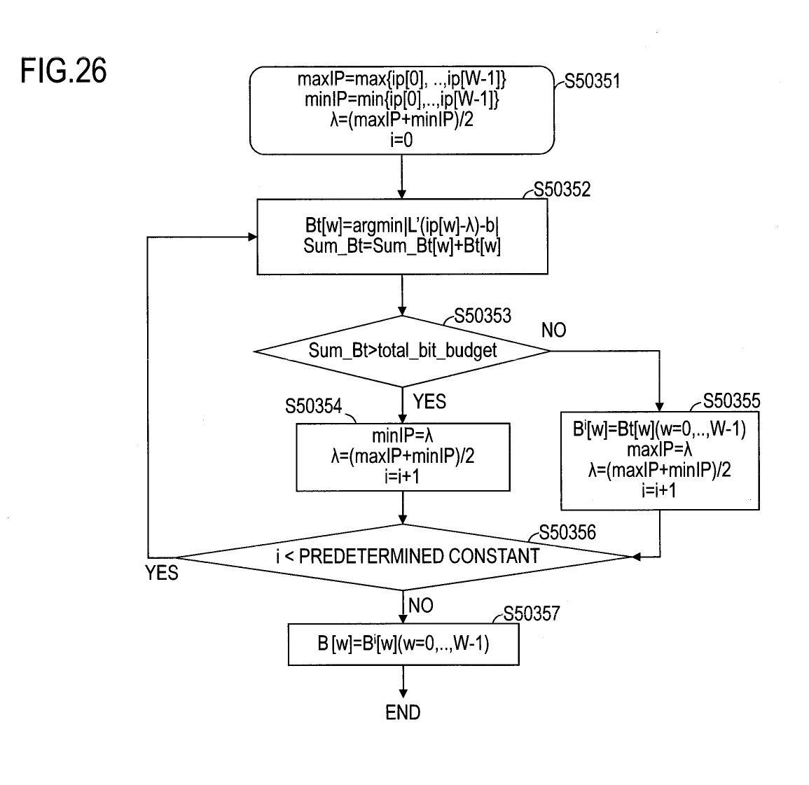

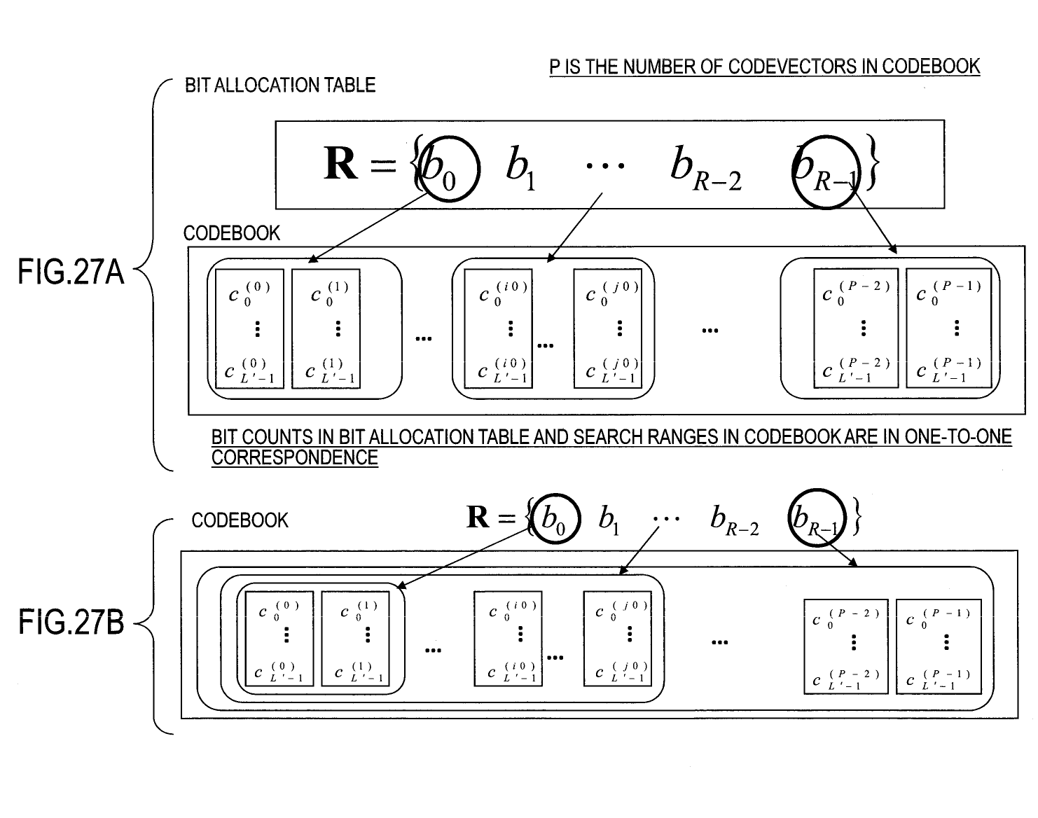

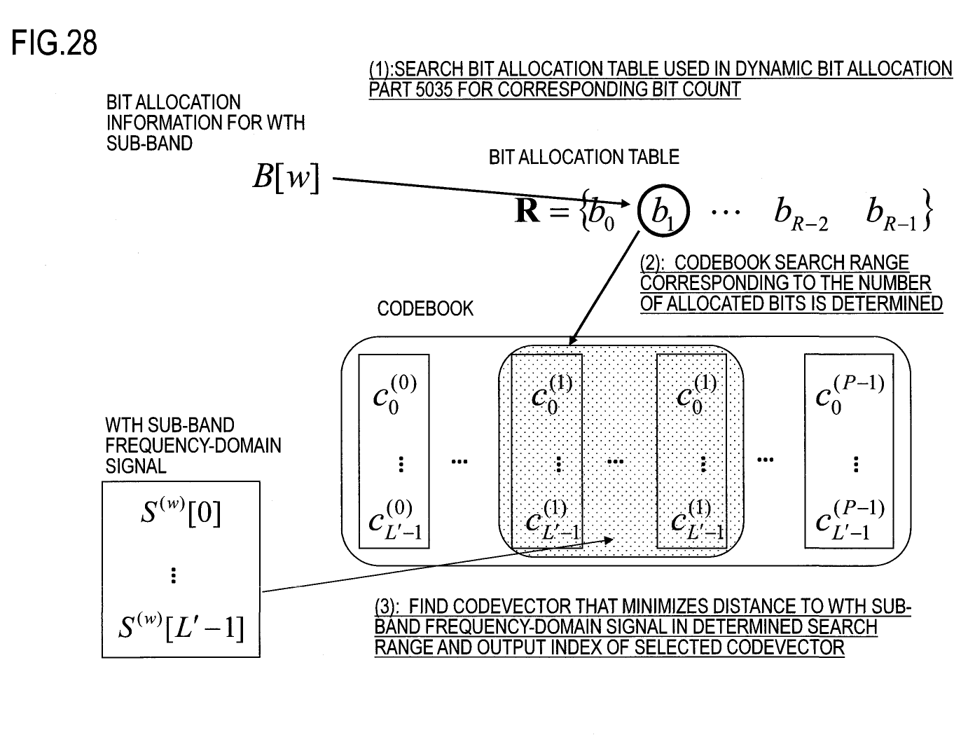

FIGS. 22A, 22B, 23A, 23B, 24A, 24B, 25A, 25B, 26, 27A, 27B and 28 are diagrams for explaining a fourth embodiment. FIG. 22A illustrates an exemplary configuration of a coding device and FIG. 22B illustrates an exemplary configuration of a decoding device. FIG. 23A illustrates an exemplary configuration of a signal coding part and FIG. 23B illustrates an exemplary configuration of a signal decoding part. FIG. 24A illustrates an exemplary configuration of a local decoding coefficient searching part and FIG. 24B illustrates an exemplary configuration of a local decoding coefficient replicating part. FIG. 25A illustrates an exemplary process flow in the coding device and FIG. 25B illustrates an exemplary process flow in the decoding device. FIG. 26 illustrates a method for calculating sub-band bit allocation information, FIGS. 27A and 27B illustrates relationships between bit allocation tables and codebooks and FIG. 28 illustrates a method for selecting a code index. Source signal sequences in the embodiment are sub-band frequency-domain signal sequences (as in the third embodiment).

Coding Device

The coding device 500 includes a frame building part 1010, a band dividing part 3050, a signal coding part 5030, a signal decoding part 5031, a local decoding coefficient searching part 5000, and a code multiplexing part 5040. The frame building part 1010 and the band dividing part 3050 are the same as those of the coding device 300 of the third embodiment.

As illustrated in FIG. 23A, the signal coding part 5030 includes a parameter calculating part 5032, a first coding part 5033, a first local decoding part 5034, a dynamic bit allocation part 5035, a second coding part 5036, and a local code multiplexing part 5037. The parameter calculating part 5032 calculates a wth sub-band first parameter from a sub-band frequency-domain signal sequence S^{(w)}[k] (w=0, . . . , W−1 and k==0, . . . , L′−1). The wth sub-band first parameter may be an average amplitude indicator Ã[w] (w=0, . . . , W−1) of the wth sub-band frequency-domain signal sequence S^{(w)}[k] (hereinafter the indicator will be referred to as the “wth sub-band average amplitude indicator”), for example. The wth sub-band average amplitude indicator can be calculated according to the following equation.

$$\tilde{A} [ w ] = round ( A [ w ] ) \\ A [ w ] = \frac{1}{2} {log}_{2} [ \frac{1}{{L}^{′}} {\sum }_{k = 0}^{{L}^{′} - 1} {\hat{S}}^{{( w )}^{2}} [ k ] + {ɛ}_{rms} ] \\ {ɛ}_{rms} = {2}^{- 24} \qquad ( 16 )$$

The wth sub-band average amplitude indicator can be used to calculate the wth sub-band average amplitude A′[w] according to the following equation.

A′[w]=2^{Ã[w]}

Then the first coding part 5033 quantizes the wth sub-band first parameter (w=0, . . . , W−1) and outputs a first signal code index I_{A}. If the wth sub-band average amplitude indicator Ã[w] (w=0, . . . , W−1) is used as the wth sub-band first parameter, the first coding part 5033 assumes the wth sub-band average amplitude indicator Ã[w] to be a W-dimensional vector and applies vector quantization to the wth sub-band average amplitude indicator Ã[w] and outputs the index of a selected codevector as the first signal code index I_{A}. Alternatively, binary coding or Huffman coding may be used to encode the wth sub-band first parameter for each sub-band.

The first local decoding part 5034 decodes the first signal code index I_{A} and outputs a wth sub-band first decoded parameter (w=0, . . . , W−1). For example, if the first coding part 5033 has encoded the wth sub-band average amplitude indicator Ã[w], the first local decoding part 5034 outputs a wth sub-band decoded average amplitude indicator Â[w] (w=0, . . . , W−1) as the wth sub-band first decoded parameter.

The dynamic bit allocation part 5035 calculates the number of bits to be allocated to each sub-band from the wth sub-band first decoded parameter and outputs wth sub-band bit allocation information. For example, if the wth sub-band average amplitude indicator Ã[w] is used as the wth sub-band first decoded parameter, bit allocation information B[w] (w==0, . . . , W−1) for the wth sub-band is calculated as follows. First, a wth sub-band perceptual importance ip[w] (w=0, . . . , W−1) is calculated from the wth sub-band average amplitude indicator Â[w] according to the following equation.

ip[w]=Â[w]/2

Then, a binary search algorithm is used with the wth sub-band perceptual importance ip[w] and a bit allocation table R to output bit allocation information B[w] for the wth sub-band. In the dynamic bit allocation, a “water level” is selected using the binary search algorithm based on the equation given below and the “water level λ” and the wth sub-band perceptual importance ip[w] are used to calculate wth sub-band bit allocation information B[w] according to the following equation.

$$B [ w ] = {arg min}_{b ∈ R} \vert {L}^{′} \cdot ( ip [ w ] - λ ) - b \vert$$

Specifically, a method illustrated in FIG. 26 may be used for example. First, parameters (maxIP, minIP, λ, i) are initialized (S50351). Then, a Bt[w], which is a temporary value for B[w], is calculated and adds the Bt[w] and a previously calculated Bt[w] to obtain Sum_Bt (S50352). Determination is made as to whether or not Sum_Bt exceeds a maximum allocatable total number of bits (total_bit_budget) (S50353). If the determination at step S50353 is YES, the parameters (minIP, λ, i) are changed (S50354). If the determination at step S50353 is NO, Bt[w] is changed to Bⁱ[w] and the parameters (maxIP, λ, i) are changed (S50355). Determination is made as to whether or not i is less than a predetermined constant (S50356). If the determination at step S50356 is YES, the process returns to step S50352. If the determination at step S50356 is NO, Bⁱ[w] is output as bit allocation information B[w] for the wth sub-band. After a predetermined number of iterations of the search have been completed, the equation of B[w] given above is evaluated. A convergence condition for ending the iterative process may be otherwise defined to end the process. For example, when the total number of allocated bits reaches the total bit budget (total_bit_budget), the process may be ended. If the ultimate total number of bits exceeds the total bit budget, the next bit counts in the table that are below the bit counts selected according to the equation given above may be allocated to the sub-bands in ascending order of ip[w], for example, to reduce the number of allocated bits so that the total number of allocated bits falls below the total bit budget, thereby determining the ultimate wth sub-band bit allocation information.

The second coding part 5036 uses the bit allocation information B[w] to quantize the wth sub-band frequency-domain signal sequence S^{(w)}[k] and outputs a wth sub-band second signal code index I_{B}^{(w)} (w=0, . . . , W−1). It is assumed here that the bit counts in the bit allocation table are in a one-to-one correspondence with search ranges in the codebook as illustrated in FIGS. 27A and 27B. The search ranges may overlap one another. FIG. 27A illustrates an example in which search ranges do not overlap one another; FIG. 27B illustrates an example in which search ranges overlap one another. The second coding part 5036 quantizes the wth sub-band frequency-domain signal sequence S^{(w)}[k] according to the procedure illustrated in FIG. 28 and outputs a wth sub-band second signal code index I_{B}^{(w)}. First, bit allocation information B[w] is used to determine a search range in the codebook in the second coding part 5036. Here, when B[w] is less than or equal to a threshold value, coding is not performed. Then, a codevector at the minimum distance to the wth sub-band frequency-domain signal vector which is the wth sub-band frequency-domain signal sequence S^{(w)}[k] considered to be a vector is selected from the codebook search range determined from the bit allocation information B. The index of the selected codevector is output as the wth sub-band second signal code index I_{B}^{(w)}. If Euclidean distance is used as the parameter representing the distance, the codevector is selected according to Equation (17).

$${I}_{B}^{( w )} = {arg min}_{p} ( {\sum }_{k = 0}^{{L}^{′} - 1} {( {S}^{( w )} [ k ] - {c}_{k}^{( p )} )}^{2} ) \qquad ( 17 )$$

If the inner product between vectors is used as the parameter representing the distance, the codevector is selected according to Equation (18).

$${I}_{B}^{( w )} = {arg max}_{p} ( {\sum }_{k = 0}^{{L}^{′} - 1} ( {S}^{( w )} [ k ] \cdot {c}_{k}^{( p )} ) ) \qquad ( 18 )$$

Here, the pth codevector contained in the codebook is denoted as C^{(p)}=(C₀^{(p)}, C₁^{(p)}, . . . , C_{L′-}1^{(p)}). Here, Cₖ^{(p)} represents the kth element of the pth vector.

The local code multiplexing part 5037 arranges wth sub-band first signal code indices I_{A}^{(w)} and wth sub-band second signal code indices I_{B}^{(w)} in a predetermined order to generate a dataset and outputs the dataset as a code index I_{C}.

The signal decoding part 5031 decodes the code index I_{C} and outputs a decoded signal sequence Ŝ^{(w)}[k] (k=0, . . . , L′−1) and bit allocation information B[w] (S5031). The signal decoding part 5031 includes a local code demultiplexing part 5038, a first local decoding part 5034, a dynamic bit allocation part 5035, a second decoding part 5039, and a decoded parameter processing part 5044. The local code demultiplexing part 5038 reads a bit count in a predetermined position in the code index I_{C} to output the wth sub-band first signal code index I_{A}^{(w)} and the wth sub-band second signal code index I_{B}^{(w)}.

The first local decoding part 5034 decodes the wth sub-band first signal code index I_{A}^{(w)} and outputs a wth sub-band first decoded parameter. Operation of the first local decoding part 5034 is the same as the operation of the first local decoding part 5034 of the signal coding part 5030. The dynamic bit allocation part 5035 calculates the number of bits to be allocated to each sub-band from the wth sub-band first decoded parameter and outputs the number of bits as bit allocation information for the wth sub-band. Operation of the dynamic bit allocation part 5035 is the same as the dynamic bit allocation part 5035 of the signal coding part 5030.

The second decoding part 5039 uses the bit allocation information B[w] of the wth sub-band to decode the wth sub-band second signal code index I_{B}^{(w)} and outputs a wth sub-band second decoded parameter. It is assumed here that the bit counts in the bit allocation table and the search ranges in the codebook are in a one-to-one correspondence as in the second coding part 5036 of the signal coding part 5030. Decoding is performed as follows. First, the bit allocation information B[w] of the wth sub-band is used to determine a codebook search range. Then, a codevector corresponding to the wth sub-band second signal code index I_{B}^{(W)} is selected from the codebook search range determined from the bit allocation information B[w]. A codevector C^{(p)}=(C₀^{(p)}, C₁^{(p)}, . . . , C_{L′-1}^{(p)}) corresponding to the selected codevector is output as the wth sub-band second decoded parameter.

The decoded parameter processing part 5044 uses the wth sub-band first decoded parameter and the wth sub-band second decoded parameter to output a decoded signal sequence Ŝ^{(w)}[k]. For example, if the average amplitude indicator Ã[w] of the wth sub-band is used as the wth sub-band first decoded parameter and a codevector normalized so that an average amplitude of 1 is yielded is used as the wth sub-band second decoded parameter, each coefficient of the wth sub-band second decoded parameter is multiplied by the wth sub-band average amplitude calculated from the wth sub-band average amplitude indicator to calculate a decoded signal sequence Ŝ^{(w)}[k].

The local decoding coefficient searching part 5000 outputs replication shift information τ_{γ}^{(w)} from the sub-band frequency-domain signal sequence S^{(w)}[k] and the decoded signal sequence Ŝ^{(w)}[k] (S5000). As illustrated in FIG. 24A, the local decoding coefficient searching part 5000 includes a replication determining part 5001, a candidate replication shift signal sequence generating part 3002, a distance calculating part 3003, and a minimum distance shift amount finding part 3004. The replication determining part 5001 outputs a replication determination flag Flag_{d}^{(w)} indicating that a candidate replication shift signal sequence \dot{S}^{τ}[k] is to be generated (for example Flag_{d}^{(w)}=1) if the bit allocation information B[w] of the wth sub-band is less than or equal to a threshold value. On the other hand, if the bit allocation information B[w] of the wth sub-band is greater than the threshold value, the replication determining part 5001 outputs a replication determination flag Flag_{d}^{(w)} indicating that a candidate replication shift signal sequence \dot{S}_{τ}[k] is not to be generated (for example Flag_{d}^{(w)}=0).

The candidate replication shift signal sequence generating part 3002, the distance calculating part 3003, and the minimum distance shift amount finding part 3004 are the same as those of the coding device 300 of the third embodiment.

The code multiplexing part 5040 multiplexes code indices and replication shift information τᵣ^{(w)} to generate a transmitter signal (S5040). Specifically, the code multiplexing part 5040 receives code indices I_{c} and replication shift information τᵣ^{(w)} as inputs and arranges them in a predetermined order to generate one dataset. If the signal is transmitted through a network such as an IP network, the code multiplexing part 5040 adds required header information to generate packets.

Decoding Device

The decoding device 600 includes a code demultiplexing part 6041, a signal decoding part 6031, a local decoding coefficient replicating part 6100, a sub-band combining part 4051, a frequency-time transform part 2021, and an overlap-add part 2011. The combination of the sub-band combining part 4051, the frequency-time transform part 2021, and the overlap-add part 2011 will be referred to as a recovered signal generating part 4012. The code demultiplexing part 6041 reads a code index I_{C} and replication shift information τᵣ^{(w)} from a received signal and outputs them (S6041). The signal decoding part 6031 decodes the code index I_{C} and outputs a decoded signal sequence Ŝ^{(w)}[k] (k=0, . . . , L−1) and bit allocation information B[w] (S6031). The process performed by the decoding part 6031 is the same as the process performed by the signal decoding part 5031.

The local decoding coefficient replicating part 6100 generates a sub-band complementary decoded signal sequence \tilde{S}^{(w)}[k] from the decoded signal sequence Ŝ^{(w)}[k] and the replication shift information τᵣ^{(w)} (S6100). As illustrated in FIG. 24B, the local decoding coefficient replicating part 6100 includes a replication determining part 6001, a replication shift signal sequence generating part 4002, and a complementary decoded signal sequence generating part 4005. The replication determining part 6001 outputs a replication determination flag Flag_{d}^{(w)} indicating that a candidate replication shift signal sequence \dot{S}_{τ}[k] is to be generated (for example Flag_{d}^{(w)}=1), if bit allocation information B[w] of the wth sub-band is less than or equal to a threshold value. On the other hand, if the bit allocation information of the wth sub-band is greater than the threshold value, the replication determining part 6001 outputs a replication determination flag Flag_{d}^{(w)} indicating that a candidate replication shift signal sequence \dot{S}_{τ}[k] is not to be generated (for example Flag_{d}^{(w)}=0) (S6001).

The replication shift signal sequence generating part 4002 and the complementary decoded signal sequence generating part 4005 are the same as those of the decoding device 400 of the third embodiment. The sub-band combining part 4051, the frequency-time transform part 2021 and the overlap-add part 2011 are the same as those of the decoding device 400 of the third embodiment.

With the configuration described above, the coding device and the decoding device of this embodiment have the same effects as the coding and decoding devices of the third embodiments.

[Variation]

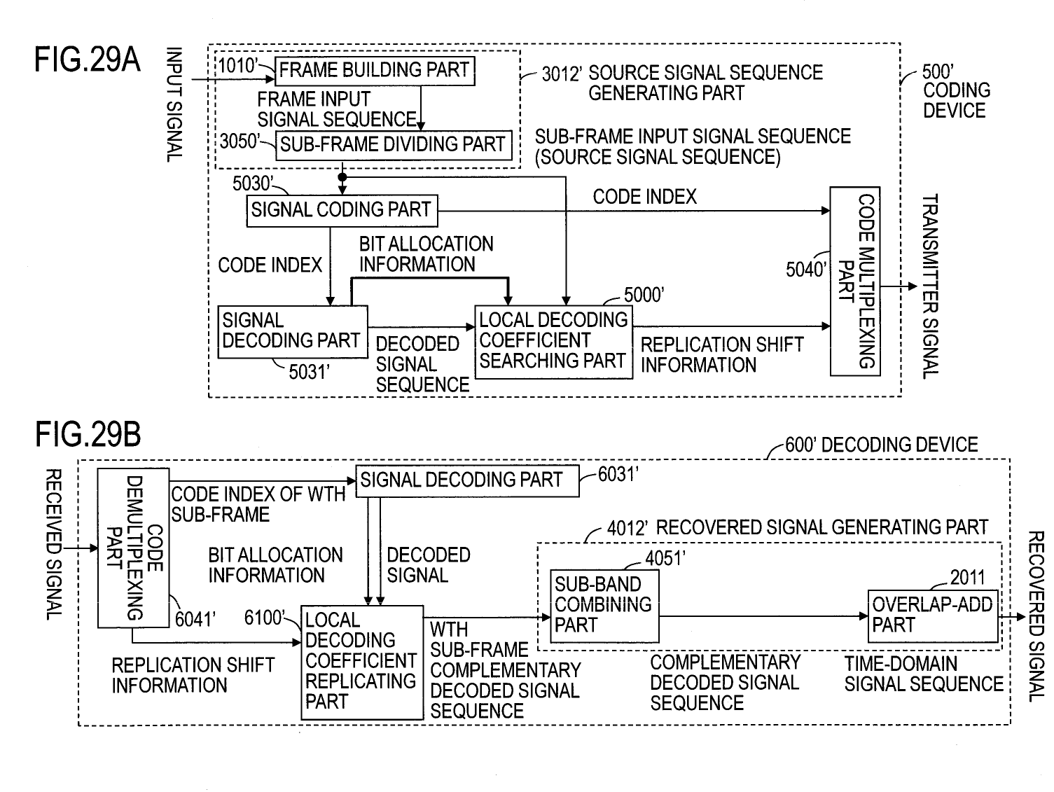

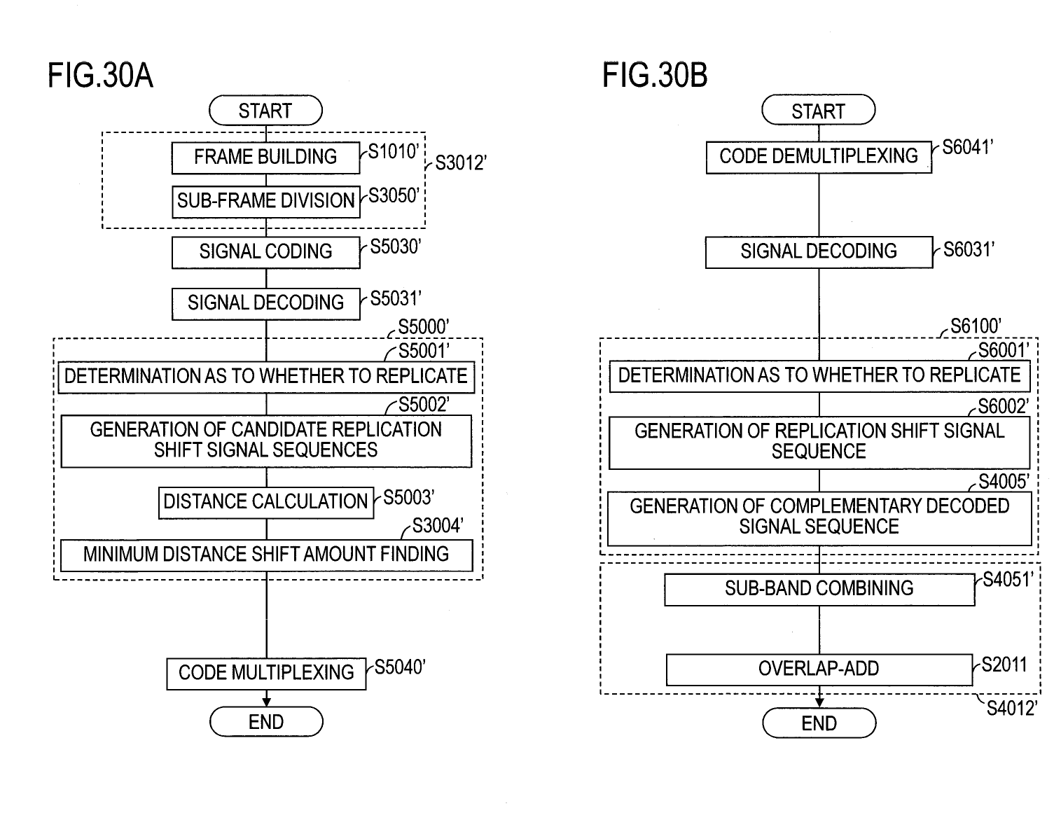

FIGS. 29A, 29B, 30A and 30B illustrate functional configurations and process flows in a variation in which source signal sequences to be coded are time-domain signal sequences in sub-frames. FIG. 29A illustrates an exemplary functional configuration of a coding device and FIG. 29B illustrates an exemplary functional configuration of a decoding device. FIG. 30A illustrates an exemplary process flow in the coding device and FIG. 30B illustrates an exemplary process flow in the decoding device.

The coding device 500′ and the decoding device 600′ are similar to the coding device 500 and the decoding device 600, respectively, with the only difference being source signal sequences. Accordingly, only processes performed by a source signal sequence generating part 3012′ and a recovered signal generating part 4012′ are different from those in the coding and decoding devices 500 and 600. The source signal sequence generating part 3012′ is the same as that of the coding device 300′ of the variation of the third embodiment. The recovered signal generating part 4012′ is the same as that of the decoding device 400′ of the variation of the third embodiment.

With the configuration described above, the coding device and the decoding device of the variation have the same effects as the coding and decoding devices of the fourth embodiment.

### Fifth Embodiment

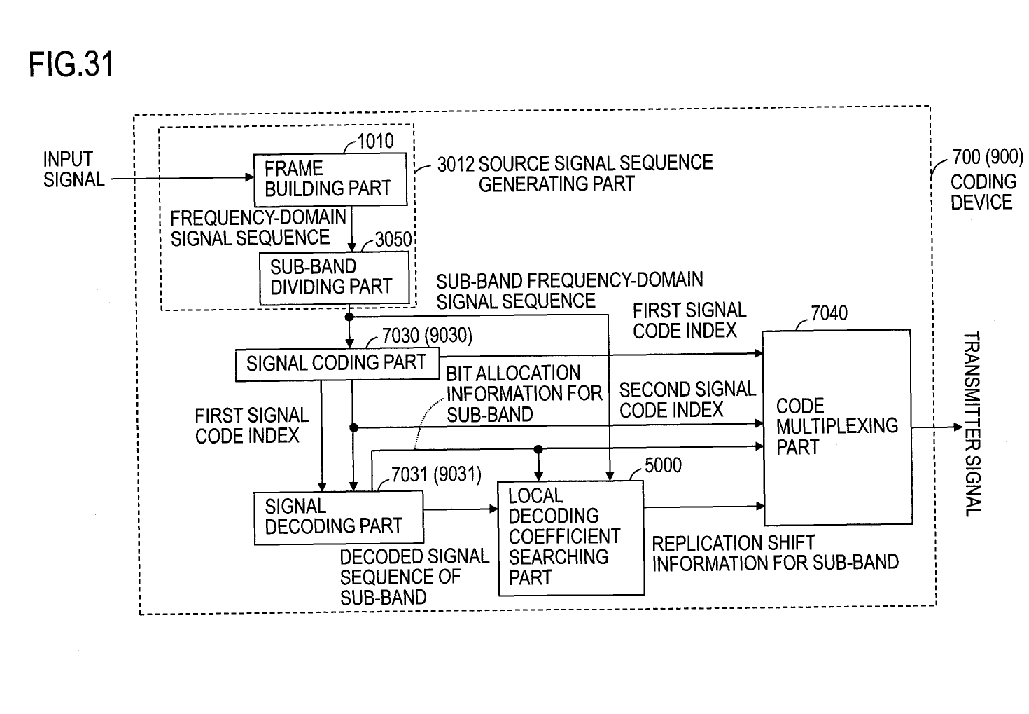

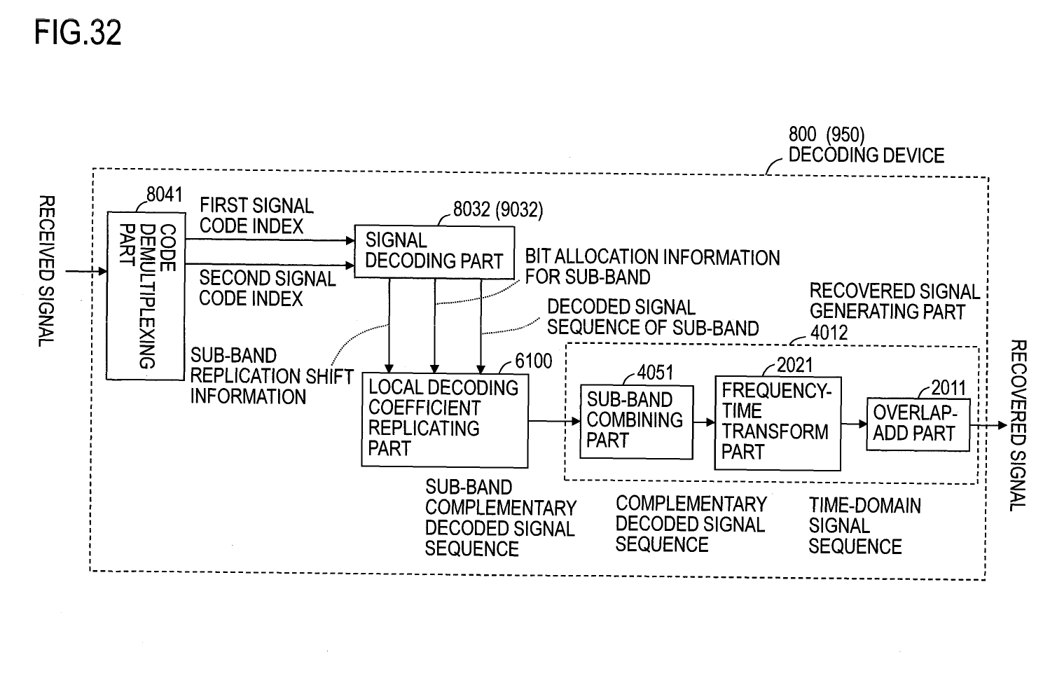

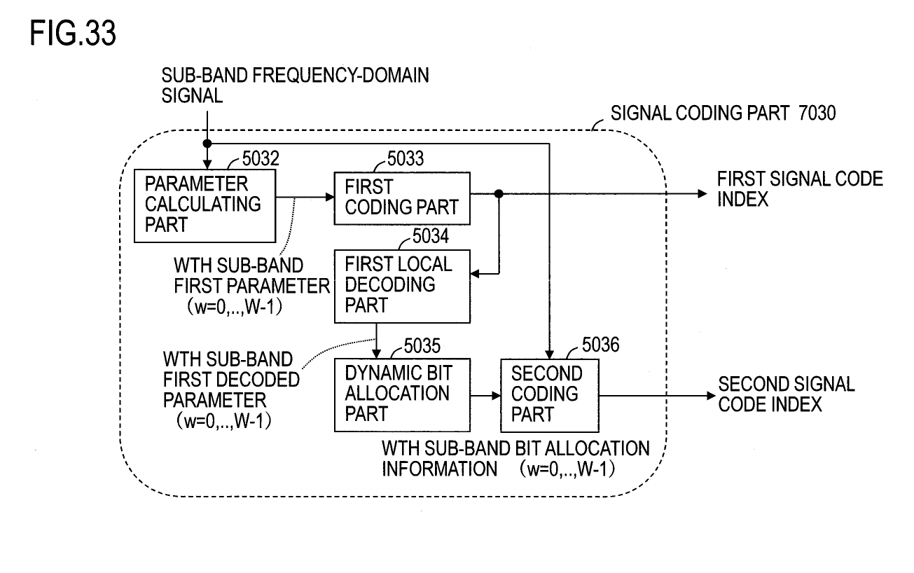

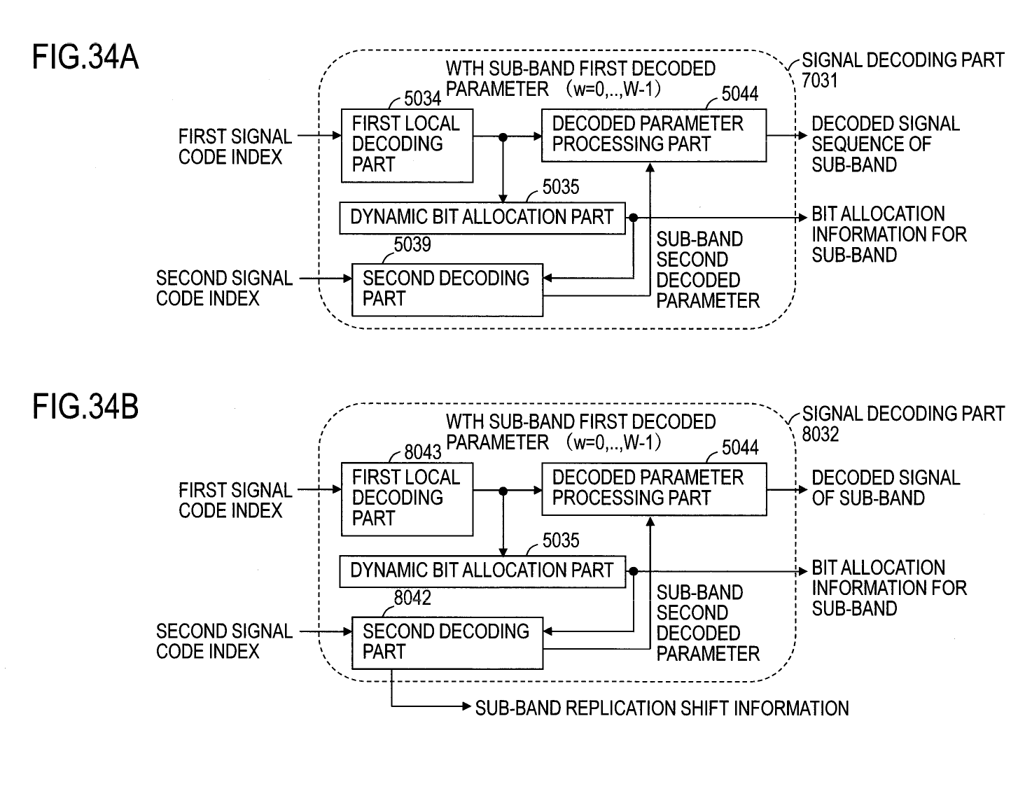

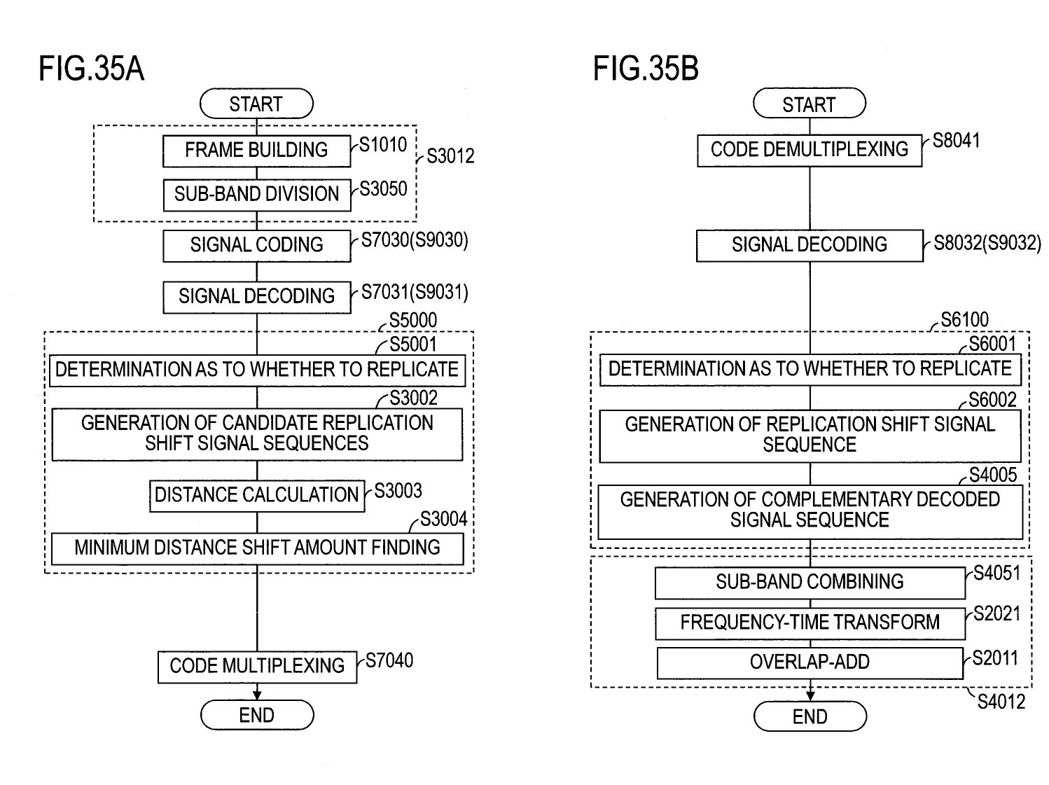

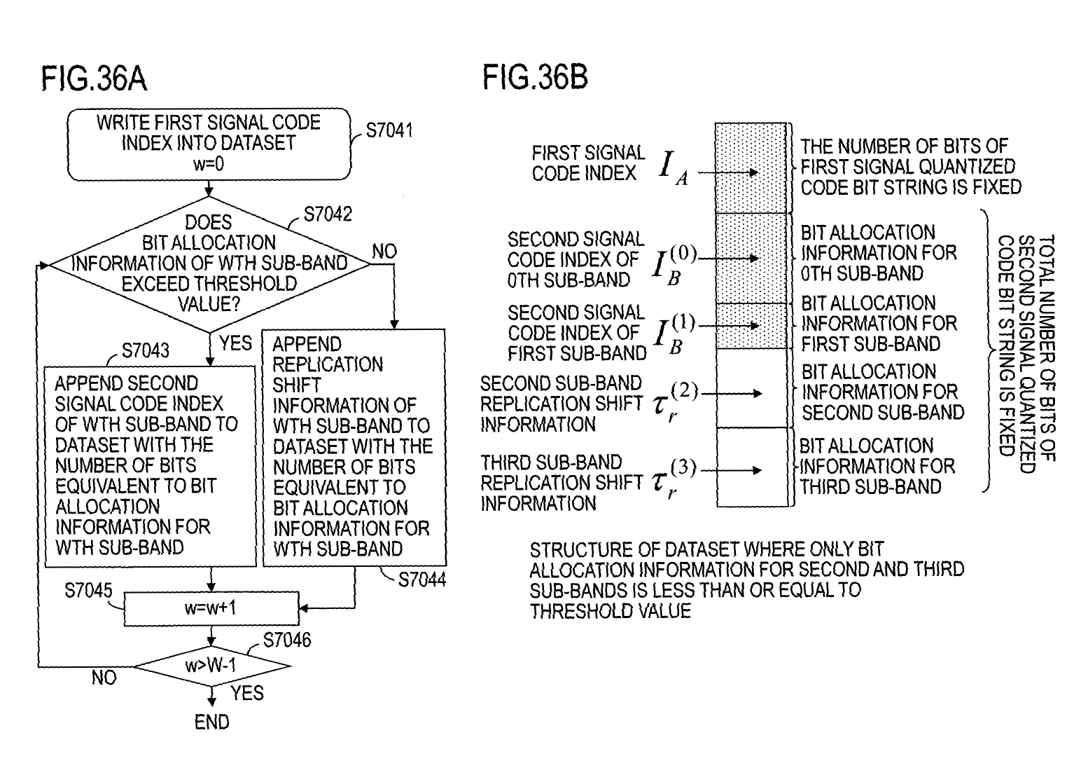

Referring to FIGS. 31, 32, 33, 34A, 34B, 35A, 35B, 36A and 36B, a fifth embodiment will be described. FIG. 31 illustrates an exemplary configuration of a coding device and FIG. 32 illustrates an exemplary configuration of a decoding device. FIG. 33 illustrates an exemplary configuration of a signal coding part, FIG. 34A illustrates an exemplary configuration of a signal decoding part in the coding device and FIG. 34B illustrates an exemplary configuration of a signal decoding part in the decoding device. FIG. 35A illustrates an exemplary process flow in the coding device and FIG. 35B illustrates an exemplary process flow in the decoding device. FIGS. 36A and 36B illustrate a method for generating a code index and a structure of a data set. Source signal sequences to be coded in the embodiment are sub-band frequency-domain signal sequences (as in the third and fourth embodiments).

Coding Device

The coding device 700 includes a frame building part 1010, a band dividing part 3050, a signal coding part 7030, a signal decoding part 7031, a local decoding coefficient searching part 5000, and a code multiplexing part 7040. The frame building part 1010 and the band dividing part 3050 are the same as those of the coding device 300 of the third embodiment and the coding device 500 of the fourth embodiment.

As illustrated in FIG. 33, the signal coding part 7030 includes a parameter calculating part 5032, a first coding part 5033, a first local decoding part 5034, a dynamic bit allocation part 5035, and a second coding part 5036. The signal coding part 7030 differs from the signal coding part 5030 of the fourth embodiment in that the signal coding part 7030 does not include the local code multiplexing part 5037. The parameter calculating part 5032, the first coding part 5033, the first local decoding part 5034, the dynamic bit allocation part 5035, and the second coding part 5036 are the same as those of the signal coding part 5030. The signal coding part 7030 receives a sub-band frequency-domain signal sequence S^{(w)}[k] (w=0, . . . , W−1 and k=0, . . . , L′−1) as inputs and outputs a first signal code index I_{A} and a second signal code index I_{B}^{(w)} (S7030).

The signal decoding part 7031 decodes the first signal code index I_{A} and the second signal code index I_{B}^{(w)} and outputs a decoded signal sequence Ŝ^{(w)}[k] (k=0, . . . , L′−1) and bit allocation information B[w] (S7031). As illustrated in FIG. 34A, the signal decoding part 7031 includes a first local decoding part 5034, a dynamic bit allocation part 5035, a second decoding part 5039, and a decoded parameter processing part 5044. The first local decoding part 5034, the dynamic bit allocation part 5035, the second decoding part 5039, and the decoded parameter processing part 5044 are the same as those of the coding device 500 of the fourth embodiment.

The local decoding coefficient searching part 5000 is the same as that of the coding device 500 of the fourth embodiment. The code multiplexing part 7040 multiplexes the first signal code index I_{A}, the second signal code index I_{B}^{(w)}, the bit allocation information B[w] and replication shift information τᵣ^{(w)} to generate a transmitter signal (S7040). For example, the code multiplexing part 7040 outputs the first signal code index I_{A} as a dataset consisting of a bit string of a fixed number of bits as illustrated in FIGS. 36A and 36B (S7041). Then the bit allocation information B[w] is compared with a threshold value (S7042). If the bit allocation information B[w] is greater than the threshold value, the second signal code index I_{B}^{(w)} of the wth sub-band is appended to the dataset as a bit string of B[w] bits (S7043). On the other hand, if the bit allocation information B[w] is less than or equal to the threshold value, the replication shift information τᵣ^{(w)} of the wth sub-band is appended to the dataset as a bit string of B[w] bits (S7044). Steps S7042 to S7044 are performed on w=0, . . . , W−1 (S7045, S7046) and a transmitter signal is output.

Decoding Device

The decoding device 800 includes a code demultiplexing part 8041, a signal decoding part 8032, a local decoding coefficient replicating part 6100, a sub-band combining part 4051, a frequency-time transform part 2021, and an overlap-add part 2011. The combination of the sub-band combining part 4051, the frequency-time transform part 2021 and the overlap-add part 2011 will be referred to as a recovered signal generating part 4012. The code demultiplexing part 8041 reads a first signal index I_{A} and a second signal code index I_{B}^{(w)} from a received signal and outputs them (S8041).

The signal decoding part 8032 decodes the first signal code index I_{A} and the second signal code index I_{B}^{(w)} and outputs a sub-band decoded signal sequence Ŝ^{(w)}[k] (k=0, . . . , L′−1), bit allocation information B[w] and replication shift information τᵣ^{(w)} (S8032). The signal decoding part 8032 includes a first local decoding part 8043, a dynamic bit allocation part 5035, a second decoding part 8042, and a decoded parameter processing part 5044. First, the first local decoding part 8043 decodes the first signal code index I_{A} and outputs a wth sub-band first decoded parameter. The dynamic bit allocation part 5035 outputs bit allocation information from the sub-band first parameter. The dynamic bit allocation part 5035 is the same as that of the decoding device 600 of the fourth embodiment. The second decoding part 8042 uses the bit allocation information B[w] of the wth sub-band to decode the wth sub-band second signal code index I_{B}^{(w)} and outputs a wth sub-band second decoded parameter and replication shift information τᵣ^{(w)}. For example, the second decoding part 8042 performs the following operation for each w (w=0, . . . , W−1). If the bit allocation information B[w] for the wth sub-band is less than or equal to a threshold value, the second decoding part 8042 reads and decodes a bit string of B[W] bits from the second signal code index I_{B}^{(w)} to output sub-band replication shift information τᵣ^{(w)}. If the bit allocation information B[w] for the wth sub-band is greater than the threshold value, the second decoding part 8042 reads and decodes a bit string of B[w] bits from the second signal code index I_{B}^{(W)} to output a second decoded parameter. The decoded parameter processing part 5044 is the same as that of the decoding device 600 of the fourth embodiment.

The local decoding coefficient replicating part 6100, the sub-band combining part 4051, the frequency-time transform part 2021, and the overlap-add part 2011 are the same as those of the decoding device 600 of the fourth embodiment.

With the configuration described above, the coding device and the decoding device of the embodiment have the same effects as the coding and decoding devices of the fourth embodiment.

[First Variation]

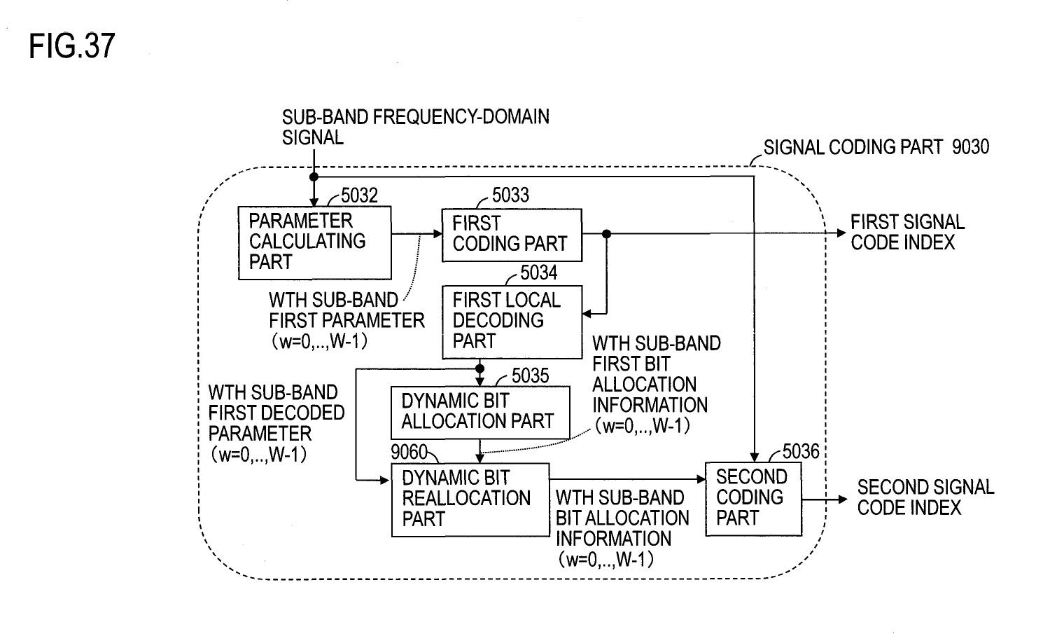

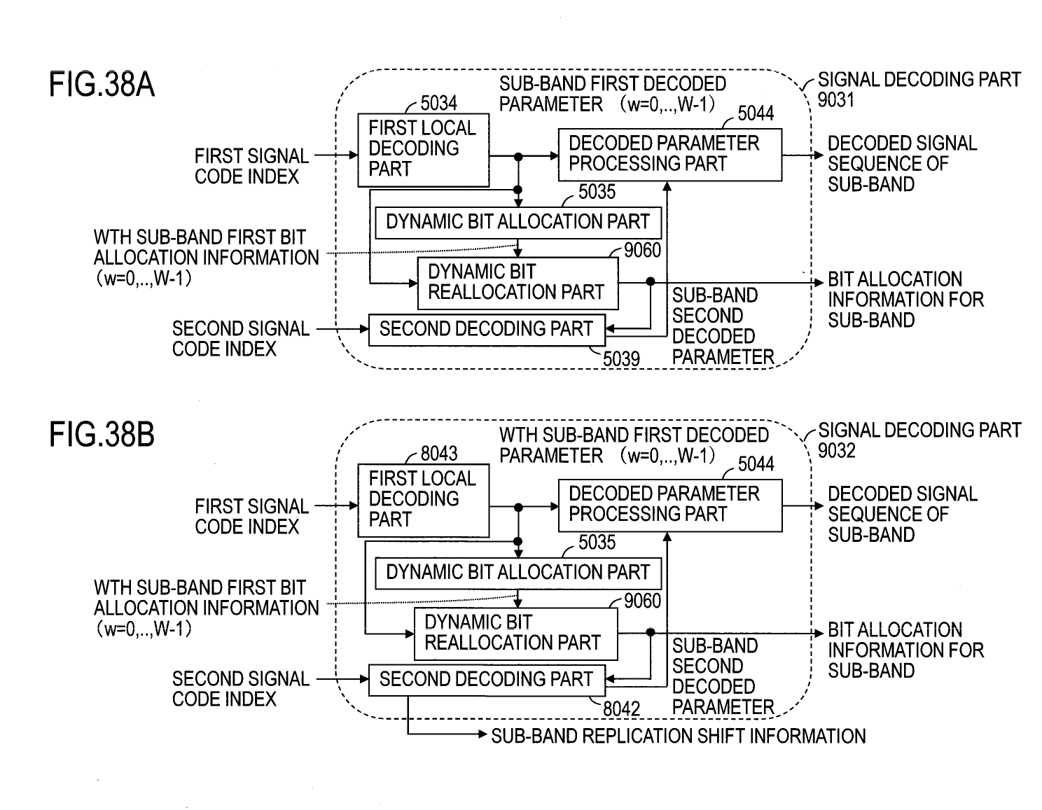

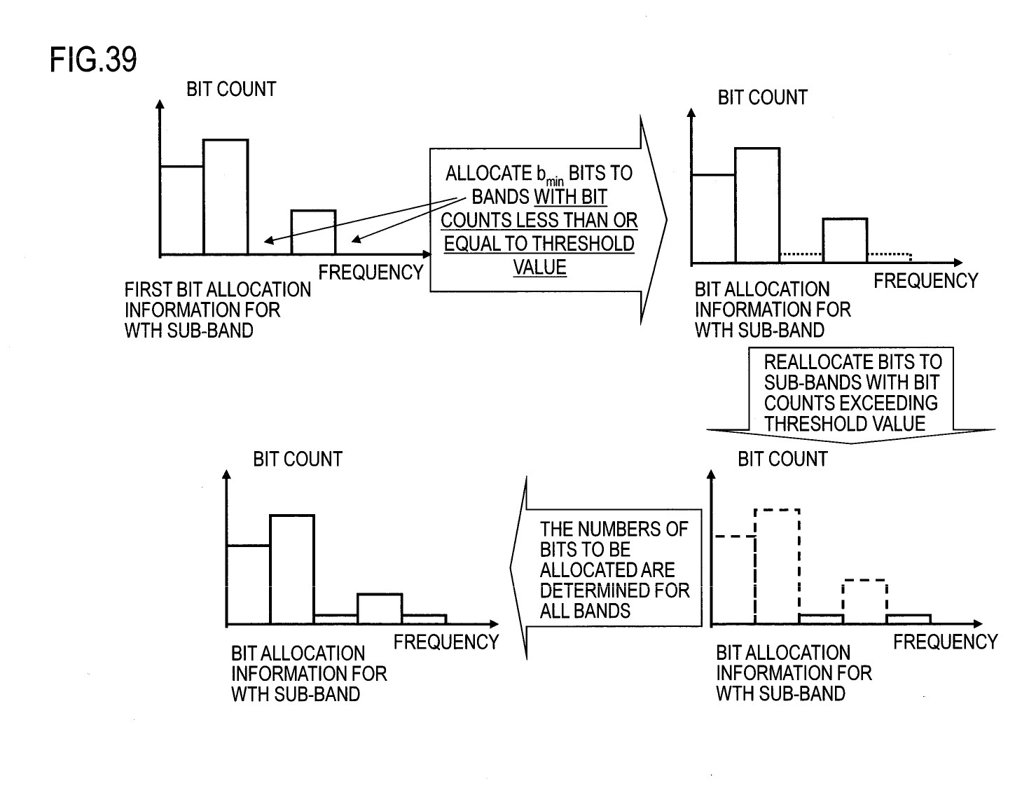

In a first variation, a dynamic bit reallocation part 9060 is used in combination with the dynamic bit allocation part 5035. FIG. 31 illustrates an exemplary configuration of a coding device and FIG. 32 illustrates an exemplary configuration of a decoding device. FIG. 35A illustrates a process flow in the coding device and FIG. 35B illustrates a process flow in the decoding device. FIG. 37 illustrates an exemplary configuration of a signal coding part and FIG. 38A illustrates an exemplary configuration of a signal decoding part in the coding device and FIG. 38B illustrates an exemplary configuration of a signal decoding part in the decoding device. FIG. 39 illustrates a process procedure in the dynamic bit reallocation part 9060.

As illustrated in FIG. 37, a signal coding part 9030 includes a parameter calculating part 5032, a first coding part 5033, a first local decoding part 5034, the dynamic bit allocation part 5035, the dynamic bit reallocation part 9060, and a second coding part 5036. The parameter calculating part 5032, the first coding part 5033, the first local decoding part 5034, the dynamic bit allocation part 5035, and the second coding part 5036 are the same as those of the signal coding part 7030 of the fifth embodiment.

The dynamic bit reallocation part 9060 generates bit allocation information as described below and illustrated in FIG. 39. An output (called “first bit allocation information B[w]” in the variation) from the dynamic bit allocation part 5035 is compared with a threshold value. If the first bit allocation information B[w] is less than or equal to the threshold value, bit allocation information of the sub-band is set to B[w]=bₘᵢₙ. The bits bₜₒₜₐₗ remaining after the bits have been allocated to the sub-band with B[w] less than or equal to the threshold are allocated to the remaining sub-bands by an operation similar to the operation of the dynamic bit allocation part 5035 to determine and output values of wth-sub-band bit allocation information for all wth sub-bands.

With the configuration described above, the coding device and the decoding device of the variation have the same effects as the coding and decoding devices of the fifth embodiment. In addition, because more appropriate numbers of bits can be allocated to sub-bands, the subjective quality can be further improved.

[Second Variation]

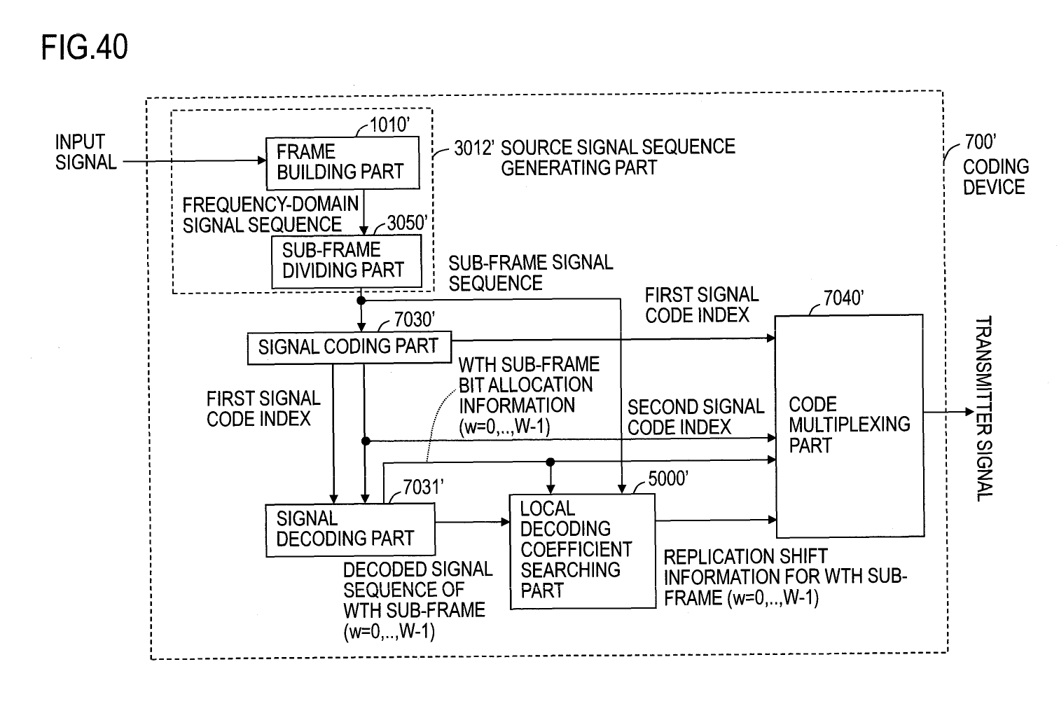

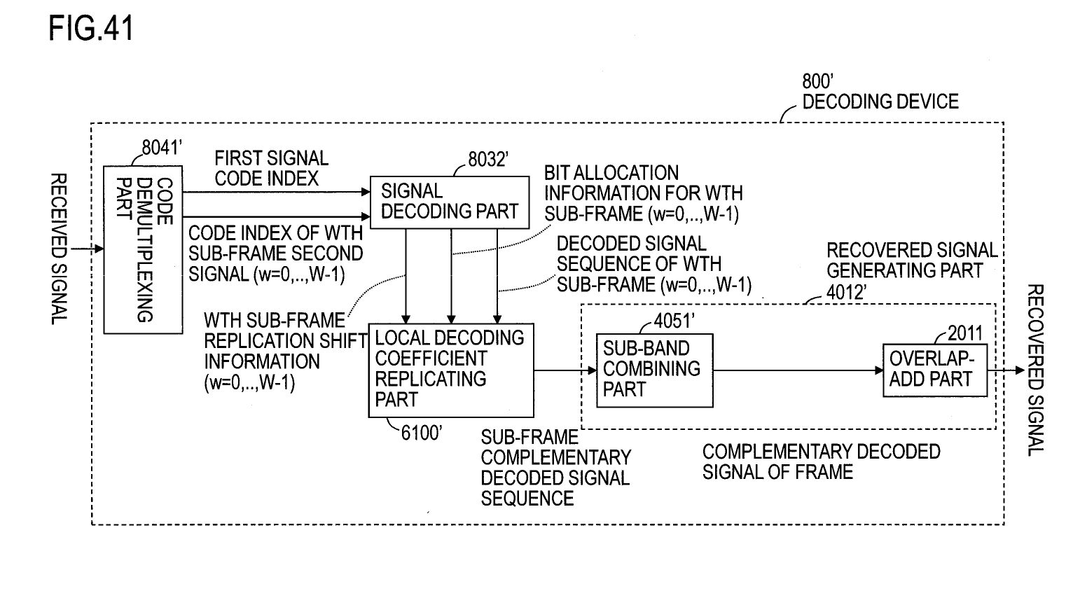

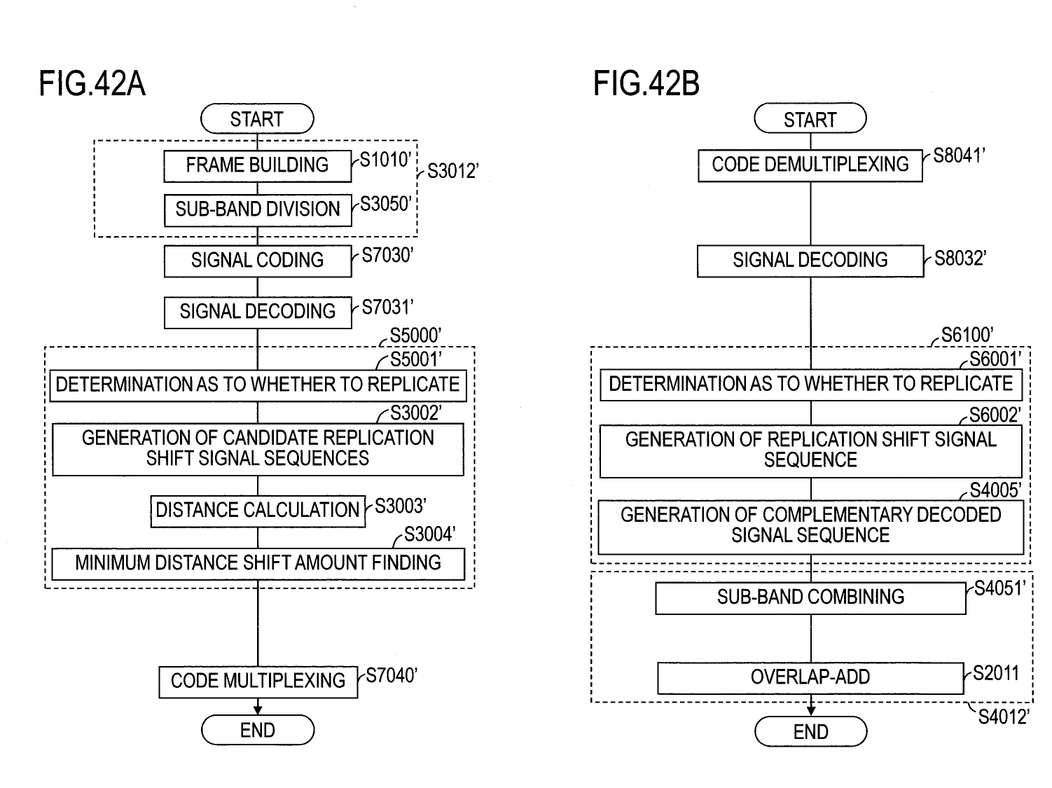

FIGS. 40, 41, 42A and 42B illustrate functional configurations and process flows in a variation in which source signal sequences are time-domain signal sequences in sub-frames. FIG. 40 illustrates an exemplary functional configuration of a coding device, FIG. 41 illustrates an exemplary functional configuration of a decoding device, FIG. 42A illustrates an exemplary process flow in the coding device, and FIG. 42B illustrates an exemplary process flow in the decoding device.

The decoding device 700′ and the decoding device 800′ are similar to the coding device 700 and the decoding device 800, respectively, with the only difference being source signal sequences. Accordingly, only processes performed by a source signal sequence generating part 3012′ and a recovered signal generating part 4012′ are different from those in the coding and decoding devices 700 and 800. The source signal sequence generating part 3012′ is the same as that of the coding device 300′ of the variation of the third embodiment and the recovered signal generating part 4012′ is the same as that of the decoding device 400′ of the variation of the third embodiment.

With the configuration described above, the coding device and the decoding device of the variation have the same effects as the coding and decoding devices of the fifth embodiment.

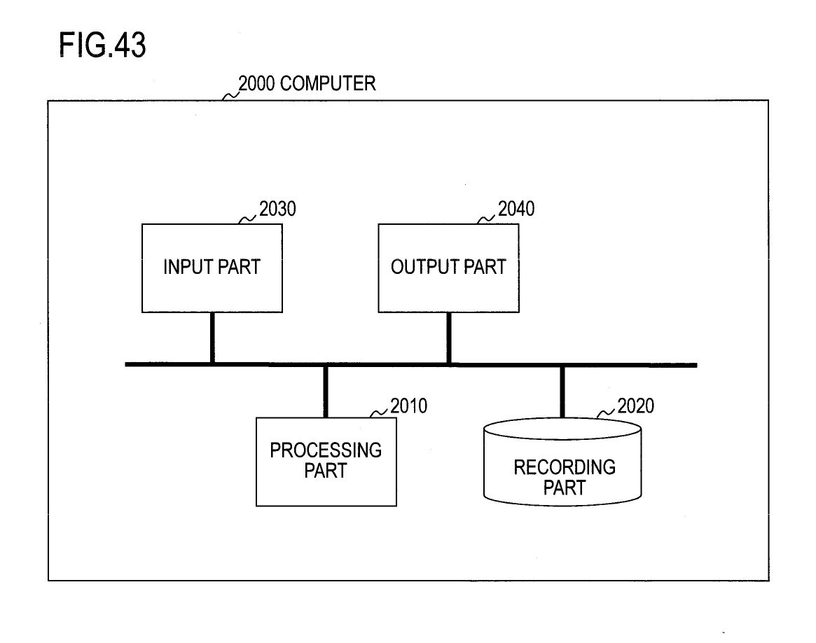

FIG. 43 illustrates an exemplary functional configuration of a computer. Any of the coding and decoding methods of the present invention can be implemented by loading a program for causing a computer 2000 to execute the steps of the preset invention into a recording part 2020 of the computer 2000 to cause components such as a processing part 2010, an input part 2030, and an output part 2040 to operate. The program may be recorded on a computer-readable recording medium and the computer may be caused to load the program from the recording medium into the computer, or the computer may be caused to download the program recorded in a server or other device to the computer through a telecommunication network.

### DESCRIPTION OF REFERENCE NUMERALS

100, 150, 300, 500, 700, 900 . . . Coding device
200, 250, 400, 600, 800, 950 . . . Decoding device
1000, 1500, 3000, 5000 . . . Local decoding coefficient searching part
1001, 1501, 2001, 3001, 5001, 6001 . . . Replication determining part
1002, 3002 . . . Candidate replication shift signal sequence generating part
1003, 1503, 3003 . . . Distance calculating part
1004, 3004 . . . Minimum distance shift amount finding part
1010 . . . Frame building part
1012, 3012 . . . Source signal sequence generating part
1030, 3030, 5030, 7030, 9030 . . . Signal coding part
1031, 2031, 3031, 4031, 5031, 6031, 7031, 8032 . . . Signal decoding part
1040, 1540, 5040, 7040 . . . Code multiplexing part
2002, 4002 . . . Replication shift signal sequence generating part
2006, 2506, 4005 . . . Complementary decoded signal sequence generating part
2011 . . . Overlap-add part
2012, 4012 . . . Recovered signal generating part
2021 . . . Frequency-time transform part
2041, 2541, 4041, 6041, 8041 . . . Code demultiplexing part
2100, 2500, 4100, 6100 . . . Local decoding coefficient replicating part
3050 . . . Band dividing part
4051 . . . Sub-band combining part
5032 . . . Parameter calculating part
5033 . . . First coding part
5034, 8043 . . . First local decoding part
5035 . . . Dynamic bit allocation part
5036 . . . Second coding part
5037 . . . Local code multiplexing part
5038 . . . Local code demultiplexing part
5039, 8042 . . . Second decoding part
5044 . . . Decoded parameter processing part
9060 . . . Dynamic bit reallocation part

1-15. (canceled)

16: A coding method comprising:
a step of calculating a number of bits to be allocated to each sub-band;
a step of outputting, for each sub-band allocated with a number of bits not less than or equal to a threshold value, a code index corresponding to a sub-band frequency-domain signal sequence of said each sub-band and a decoded signal sequence corresponding to the code index; and
a step of outputting, for each sub-band allocated with a number of bits less than or equal to a threshold value, a candidate signal shift amount as replication shift information from a plurality of predetermined candidate signal shift amounts, where the candidate signal shift amount minimizes a distance or maximizes a correlation between a signal sequence obtained by shifting by the candidate signal shift amount a decoded signal sequence of a sub-band other than said each sub-band and a sub-band frequency-domain signal sequence of said each sub-band.

17: A coding method comprising:
a step of calculating a number of bits to be allocated to each sub-frame;
a step of outputting, for each sub-frame allocated with a number of bits not less than or equal to a threshold value, a code index corresponding to a sub-frame signal sequence in time-domain of said each sub-frame and a decoded signal sequence corresponding to the code index; and
a step of outputting, for each sub-frame allocated with a number of bits less than or equal to a threshold value, a candidate signal shift amount as replication shift information from a plurality of predetermined candidate signal shift amounts, where the candidate signal shift amount minimizes a distance or maximizes a correlation between a signal sequence obtained by shifting by the candidate signal shift amount a decoded signal sequence of a sub-frame other than said each sub-frame and a sub-frame signal sequence of said each sub-frame.

18: A decoding method comprising:
a step of decoding a code index of each sub-band to output a sub-band decoded signal sequence of said each sub-band;
a step of, when a sub-band replication shift signal sequence of said each sub-band is to be generated, generating a signal sequence as a sub-band replication shift signal sequence of said each sub-band, the signal sequence obtained by shifting a sub-band decoded signal sequence of a sub-band other than said each sub-band by a candidate signal shift amount indicated by replication shift information of said each sub-band;
a step of, when a sub-band replication shift signal sequence of said each sub-band is to be generated, outputting the generated sub-band replication shift signal sequence as a complementary decoded signal sequence of said each sub-band and, when a sub-band replication shift signal sequence of said each sub-band is not to be generated, outputting the sub-band decoded signal sequence of said each sub-band as a sub-band complementary decoded signal sequence of said each sub-band; and
a step of combining sub-band complementary decoded signal sequences of sub-bands to generate a frequency-domain sub-band complementary decoded signal sequence and transforming the frequency-domain sub-band complementary decoded signal sequence to a time-domain to generate a decoded audio signal.

19: The decoding method according to claim 18, further comprising,
a step of determining based on a replication determination flag whether the sub-band replication shift signal sequence of said each sub-band is to be generated using the sub-band decoded signal sequence of said each sub-band or not.

20: A decoding method comprising:
a step of decoding a code index of each sub-frame to output a sub-frame decoded signal sequence of said each sub-frame;
a step of, when a candidate sub-frame replication shift signal sequence of said each sub-frame is to be generated, generating a signal sequence as a candidate sub-frame replication shift signal sequence of said each sub-frame, the signal sequence obtained by shifting a sub-frame decoded signal sequence of a sub-frame other than said each sub-frame by a candidate signal shift amount indicated by replication shift information of said each sub-frame;
a step of, when a candidate sub-frame replication shift signal sequence of said each sub-frame is to be generated, outputting the generated candidate sub-frame replication shift signal sequence as a complementary decoded signal sequence of said each sub-frame and, when a candidate sub-frame replication shift signal sequence of said each sub-frame is not to be generated, outputting the sub-frame decoded signal sequence of said each sub-frame as a sub-frame complementary decoded signal sequence of said each sub-frame; and
a step of combining sub-frame complementary decoded signal sequences of sub-frames to generate a decoded audio signal.

21: A coding device comprising:
a part for calculating a number of bits to be allocated to each sub-band;
a part for outputting, for each sub-band allocated with a number of bits not less than or equal to a threshold value, a code index corresponding to a sub-band frequency-domain signal sequence of said each sub-band and a decoded signal sequence corresponding to the code index; and
a part for outputting, for each sub-band allocated with a number of bits less than or equal to a threshold value, a candidate signal shift amount as replication shift information from a plurality of predetermined candidate signal shift amounts, where the candidate signal shift amount minimizes a distance or maximizes a correlation between a signal sequence obtained by shifting by the candidate signal shift amount a decoded signal sequence of a sub-band other than said each sub-band and a sub-band frequency-domain signal sequence of said each sub-band.

22: A coding device comprising:
a part for calculating a number of bits to be allocated to each sub-frame;
a part for outputting, for each sub-frame allocated with a number of bits not less than or equal to a threshold value, a code index corresponding to a sub-frame signal sequence in time-domain of said each sub-frame and a decoded signal sequence corresponding to the code index; and
a part for outputting, for each sub-frame allocated with a number of bits less than or equal to a threshold value, a candidate signal shift amount as replication shift information from a plurality of predetermined candidate signal shift amounts, where the candidate signal shift amount minimizes a distance or maximizes a correlation between a signal sequence obtained by shifting by the candidate signal shift amount a decoded signal sequence of a sub-frame other than said each sub-frame and a sub-frame signal sequence of said each sub-frame.

23: A decoding device comprising:
a part for decoding a code index of each sub-band to output a sub-band decoded signal sequence of said each sub-band;
a part for, when a sub-band replication shift signal sequence of said each sub-band is to be generated, generating a signal sequence as a sub-band replication shift signal sequence of said each sub-band, the signal sequence obtained by shifting a sub-band decoded signal sequence of a sub-band other than said each sub-band by a candidate signal shift amount indicated by replication shift information of said each sub-band;
a part for, when a sub-band replication shift signal sequence of said each sub-band is to be generated, outputting the generated sub-band replication shift signal sequence as a complementary decoded signal sequence of said each sub-band and, when a sub-band replication shift signal sequence of said each sub-band is not to be generated, outputting the sub-band decoded signal sequence of said each sub-band as a sub-band complementary decoded signal sequence of said each sub-band; and
a part for combining sub-band complementary decoded signal sequences of sub-bands to generate a frequency-domain sub-band complementary decoded signal sequence and transforming the frequency-domain sub-band complementary decoded signal sequence to a time-domain to generate a decoded audio signal.

24: The decoding device according to claim 23, further comprising,
a part for determining based on a replication determination flag whether the sub-band replication shift signal sequence of said each sub-band is to be generated using the sub-band decoded signal sequence of said each sub-band or not.

25: A decoding device comprising:
a part for decoding a code index of each sub-frame to output a sub-frame frequency-domain signal sequence of said each sub-frame;
a part for, when a candidate sub-frame replication shift signal sequence of said each sub-frame is to be generated, generating a signal sequence as a candidate sub-frame replication shift signal sequence of said each sub-frame, the signal sequence obtained by shifting a sub-frame decoded signal sequence of a sub-frame other than said each sub-frame by a candidate signal shift amount indicated by replication shift information of said each sub-frame;
a part for, when a candidate sub-frame replication shift signal sequence of said each sub-frame is to be generated, outputting the generated candidate sub-frame replication shift signal sequence as a complementary decoded signal sequence of said each sub-frame and, when a candidate sub-frame replication shift signal sequence of said each sub-frame is not to be generated, outputting the sub-frame decoded signal sequence of said each sub-frame as a sub-frame complementary decoded signal sequence of said each sub-frame; and
a part for combining sub-frame complementary decoded signal sequences of sub-frames to generate a decoded audio signal.

26: A computer-readable recording medium that stores a program causing a computer to execute the steps of the method according to claim 16.

27: A computer-readable recording medium that stores a program causing a computer to execute the steps of the method according to claim 17.

28: A computer-readable recording medium that stores a program causing a computer to execute the steps of the method according to claim 18.

29: A computer-readable recording medium that stores a program causing a computer to execute the steps of the method according to claim 19.

30: A computer-readable recording medium that stores a program causing a computer to execute the steps of the method according to claim 20.
